(19) United States
(12) Patent Application Publication
(10) Pub. No.: US 2022/0284402 A1
(43) Pub. Date: Sep. 8, 2022

(54) ARTIFICIAL INTELLIGENCE DRIVEN PERSONALIZATION FOR ELECTRONIC MEETING CREATION AND FOLLOW-UP

(71) Applicant: Microsoft Technology Licensing, LLC, Redmond, WA (US)

(72) Inventors: Vipindeep VANGALA, Hyderabad (IN); Nishchay KUMAR, Hyderabad (IN); Prateek GUPTA, Noida (IN)

(21) Appl. No.: 17/192,245

(22) Filed: Mar. 4, 2021

(51) Int. Cl. G06Q 10/10; G06N 5/04; G06N 20/00; H04L 29/06

(52) U.S. Cl. CPC G06Q 10/1095; G06N 5/04; G06N 20/00; G06Q 10/107; H04L 65/403; H04L 67/306

(57) ABSTRACT

A computing system obtains a keyword and an identifier for a user, where a meeting is to be scheduled between the user and at least one other individual. Based upon the keyword and the identifier for the user, the computing system obtains an identifier for an invitee to the meeting and/or an identifier for content that is to be included in an electronic invitation for the meeting via a computer-implemented user graph for the user. The computing system causes the identifier for the invitee and/or the content to be included in the electronic invitation. The electronic invitation for the meeting is transmitted to electronic accounts of invitees that are identified in the electronic invitation. Data is generated during the meeting by a meeting application that hosts the meeting, and the user graph is modified based upon the data. Subsequently, the computing system obtains a task via the modified user graph.

### BACKGROUND

Meetings organized via computer-executable applications play an ever-increasing role in productivity and collaboration in a variety of settings. Conventionally, in order to organize a meeting, a computing device operated by a meeting organizer receives (manual) input that causes an electronic invitation for the meeting to be generated. The input may include a title (i.e., a topic) of the meeting, a start datetime for the meeting, an end datetime for the meeting (or an expected duration of the meeting), identifiers for computer-readable content (e.g., documents) that are to be attached to or linked to within the electronic invitation for the meeting, and identifiers for invitees of the meeting. After finalizing the electronic invitation, the computing device operated by the meeting organizer causes the electronic invitation to be transmitted to electronic accounts of the invitees. For instance, the computing device operated by the meeting organizer causes the electronic invitation to be sent to email accounts of the invitees. Computing devices operated by the invitees may present the electronic invitation to the invitees, where the computing devices may receive indications from the invitees as to whether or not the electronic invitation is accepted (i.e., whether the invitees are planning on being an attendee of the meeting). The computing device operated by the meeting organizer may receive the indications, and present the indications to the meeting organizer. At the start datetime for the meeting, the meeting occurs. For instance, the meeting occurs over a network connection (e.g., the Internet, intranet, etc.) via instances of a meeting application executing on computing devices operated by attendees of the meeting. During the meeting, the attendees of the meeting communicate with one another via their respective computing devices using audio-based communication, video-based communication, text-based communication, or a combination thereof.

Conventional technologies pertaining to meeting organization via computer-executable applications suffer from various deficiencies. First, conventional technologies tend not to sufficiently aid a meeting organizer in identifying invitees for a meeting. For instance, conventional technologies present a list of individuals to the meeting organizer that the meeting organizer has most recently contacted or a list of individuals that the meeting organizer most frequently contacts. Conventional technologies may utilize auto-complete technologies when the meeting organizer is manually inputting identifiers for invitees to the meeting, whereby an identifier for an invitee is presented to the user based upon the identifier for the invitee being partially input by the meeting organizer. The aforementioned lists are not helpful in scenarios where individuals exist that should be invited to the meeting, but do not meet the criteria for being included in either list. Additionally, such lists do not present identifiers for individuals that are not contacts of the meeting organizer. Auto-complete technologies have limited usefulness for similar reasons. Thus, a computing device operated by the meeting organizer frequently receives extensive manual input in order to identify invitees for the meeting and send an electronic invitation to electronic accounts of the invitees. This is particularly problematic due to the emergence of electronic meeting applications that support a relatively large number of attendees (e.g., fifty or more). Second, conventional technologies tend not to sufficiently aid the meeting organizer in identifying computer-readable content (e.g., a document, an email, a spreadsheet, etc.) that is relevant to the meeting and that is to be included in the electronic invitation (either as an attachment or as a link to a website hosting the content) for the meeting. For instance, conventional technologies present a list of content that the meeting organizer has most recently accessed or a list of content that the meeting organizer has most frequently accessed; however, such lists are not helpful in scenarios where content exists that is relevant to the meeting, but such content does not meet the criteria for being included in either list. Additionally, such lists do not present content to the meeting organizer that the meeting organizer has not accessed. Thus, the computing device operated by the meeting organizer frequently receives extensive manual input in order to include content in the electronic invitation for the meeting.

### SUMMARY

The following is a brief summary of subject matter that is described in greater detail herein. This summary is not intended to be limiting as to the scope of the claims.

Disclosed herein are various technologies pertaining to artificial intelligence (AI) driven personalization for electronic meeting creation and follow-up. With more specificity, an AI personalization application is disclosed herein that is configured to identify invitees for a meeting and computer-readable content that is to be included in (i.e., attached to or linked to in) an electronic invitation for the meeting. The invitees and the computer-readable content for the meeting are obtained via a computer-implemented user graph for a user (i.e., a meeting organizer), and optionally, a computer-implemented tenancy graph of a tenancy to which the user belongs. The AI personalization application is also configured to identify follow-up tasks via the user graph, and optionally, the tenancy graph, where the follow-up task pertain to the meeting and are to be completed by individuals subsequent to occurrence of the meeting.

For example, if a user (e.g., a meeting organizer) opts-in, a graph application obtains (i.e., receives or generates) user activity data of the user from a plurality of applications and generates and maintains a user graph for the user based upon the user activity data. The user activity data may include historical activity data of the user and/or real-time data of the user collected via a plugin or interop communication. The user graph includes nodes and edges connecting the nodes. Each node represents an entity, where the entity may be a contact of the user (i.e., a different user), a topic, content (e.g., an email, a slideshow presentation, etc.) that has been associated with (e.g., created by, edited by, accessed by, able to be accessed by, and/or viewed by) the user, a commitment of the user (e.g., a meeting that the user has attended or will attend), or a tenancy of the user (e.g., a group or an organization to which the user belongs). Each edge is assigned criteria that is indicative of a relationship between entities represented by nodes that are connected by a respective edge. In an example, when an email application transmits an email authored by the user to a contact of the user, the graph application identifies at least one seed node in the user graph representing a topic that has been assigned to the email (or a subtopic of the email, or a related topic to the topic of the email, or a name of a person referenced in the email, or the like). In the example, the graph application generates a second level node representing the email. The second level node may include metadata for the email. The graph application also generates a first edge that connects the seed node(s) to the second level node, where the first edge is assigned criteria that indicates that the email belongs to the topic. Following the example, the graph application may also identify a third level node in the user graph representing the contact of the user. The graph application also generates a second edge and connects the second level node to the third level node via the second edge. In this example, the second edge is assigned second criteria indicating that the email was sent by the user to the contact of the user.

In some embodiments, the graph application also generates and maintains a tenancy graph for a tenancy to which the user belongs (e.g., a group, a team, or an organization). The tenancy graph is similar to the user graph, that is, the tenancy graph has nodes representing entities and edges connecting the nodes. Each edge is assigned criteria that is indicative of a relationship between entities represented by nodes that are connected by a respective edge. However, unlike the user graph, nodes representing content in the tenancy graph represent content that is associated with the tenancy and that is accessible to the user, but that may or may not have been previously accessed by the user. For this reason, the tenancy graph may include nodes and edges (e.g., representing topics) that are not represented in the user graph and vice versa.

A meeting surface application receives an indication that the user wishes to schedule a meeting. The meeting may be a meeting that occurs over a network connection between two or more individuals via at least two instances of a meeting application executing on at least two computing devices, a meeting that occurs in person between two or more individuals (while at least one instance of the meeting application is executing on a computing device in the presence of the two or more individuals during the meeting), or a meeting that occurs partly in person and partly over a network connection between three or more individuals. According to some embodiments, the meeting surface application is part of the meeting application. According to other embodiments, the meeting surface application is separate from the meeting application (e.g., the meeting surface application is an email application with scheduling and calendar functionality that communicates with the meeting application in order to schedule meetings that occur on the meeting application).

The meeting surface application receives one or more keywords that pertain to the meeting. According to some embodiments, the one or more keywords are a title for the meeting that is received as input from the user. According to other embodiments, the one or more keywords are a title of computer-readable content that is selected by the user. The AI personalization application can obtain (i.e., generate or receive) the one or more keywords and an identifier for the user. For instance, the meeting surface application transmits the one or more keywords and the identifier for the user to the AI personalization application.

Based upon the one or more keywords and the identifier for the user, the AI personalization application obtains identifiers for one or more invitees (or potential invitees) for the meeting and/or computer-readable content (e.g., a document, a spreadsheet, a slideshow presentation, an email, a copy of a real-time message, an audio recording, a video recording, etc.) that is to be (or that may be) included in an electronic invitation for the meeting via the user graph for the user. With more specificity, according to some embodiments, the AI personalization application identifies a topic based upon the one or more keywords. The AI personalization application also identifies the user graph for the user (from amongst a plurality of graphs) based upon the identifier for the user. The AI personalization application then walks the user graph based on the topic in order to identify a subgraph for the topic. With more specificity, the AI personalization application identifies at least one node in the user graph that represents the topic (i.e., at least one seed node). The AI personalization application then traverses edges that connect the seed node(s) to reach second level nodes in the user graph (“a first level of expansion”). In an example, the second level nodes represent contacts of the user. As the second level nodes are connected to the at least one node via at least one edge, the meeting may be relevant to some or all of the contacts, and some or all of the contacts are invitees (or potential invitees) to the meeting. For each second level node (or for selected second level nodes of a given type), the AI personalization application may traverse edges connecting the second level nodes to third level nodes (“a second level of expansion”). In an example, the third level nodes represent computer-readable content (e.g., documents, emails, etc.) that are relevant or potentially relevant to the meeting. Alternatively, the second level of expansion may identify the relevant or potentially relevant computer-readable content and the third level of expansion may identify the invitees or the potential invitees. This process may continue until the AI personalization application reaches a threshold level of expansion (e.g., three levels of expansion), whereupon the subgraph identification is completed. According to some embodiments, the AI personalization application also performs a walk of one or more tenancy graphs of the user based on the topic in order to identify one or more additional subgraphs for the topic. The AI personalization application may utilize transitive closure properties of the user graph and/or the tenancy graph in order to optimize subgraph identification.

According to some embodiments, the potential invitees and/or the content that is potentially relevant to the meeting identified via the user graph are ranked based upon suitable criteria (e.g., a number of edges that occur between the topic node and nodes representing each of the potential invitees and/or the content), and identifiers for the invitees and/or identifiers for the content that are ranked above a threshold level (e.g., top five, top ten, etc.) are automatically included in the electronic invitation for the meeting. According to other embodiments, the AI personalization application causes identifiers for the potential invitees and/or identifiers for the potentially relevant content to be displayed within a graphical user interface (GUI) for the meeting surface application. The AI personalization application may rank the potential invitees such that potential invitees that are likely to be required to attend the meeting are presented to the user at a beginning of a list that includes the potential invitees. The user examines the identifiers for the potential invitees and the meeting surface application receives, from the user, a selection of one or more invitees that are to be invited to the meeting. The user also examines the identifiers for the potentially relevant content and the meeting surface application receives, from the user, a selection of content that is to be included in the electronic invitation for the meeting. The AI personalization application may rank the potentially relevant content such that potentially relevant content that is likely to be required for the meeting is presented to the user at a beginning of a list that includes the potentially relevant content.

It is to be understood that selection of invitees for the meeting and/or selection of content that is to be included in the electronic invitation may cause the AI personalization application to generate further subgraphs from which the AI personalization application obtains further invitees or potential invitees and/or further relevant content or further potentially relevant therefrom. For instance, subsequent to presenting identifiers for potential invitees to the meeting within the GUI, the meeting surface application receives a selection of an identifier of an invitee from amongst the identifiers for the potential invitees, thereby causing the invitee to be included in the electronic invitation. The meeting surface application may transmit the identifier for the invitee to the AI personalization application. Using processes similar to those set forth above, the AI personalization application may perform a walk of the tenancy graph of the user (based upon the identifier for the invitee, the one or more keywords, and/or the identifier for the user) to identify second invitees or second potential invitees and/or second relevant content or second potentially relevant content. The AI personalization application may transmit identifiers for the second invitees or the second potential invitees and/or the identifiers for the second content or the second potentially relevant content to the meeting surface application, where the meeting surface application may present such identifiers within the GUI. In this manner, the AI personalization application may identify invitees to the meeting and/or content that is to be included in the electronic invitation for the meeting, even when the invitees are not contacts of the user and/or the content has not been accessed by the user.

The meeting surface application may also receive a start datetime (i.e., a start date and a corresponding time on the start date) and an end datetime (i.e., an end date and a corresponding time on the end date) for the meeting. The meeting surface application causes the electronic invitation for the meeting to be transmitted to electronic accounts of each of the invitees identified in the electronic invitation (some or all of which have been identified via the user graph and/or the tenancy graph), where the electronic invitation includes a title of the meeting, identifiers for invitees of the meeting, attachments and/or links to content that is relevant to the meeting (some or all of which have been identified via the user graph and/or the tenancy graph), the start datetime, the end datetime, and optionally comments set forth by the meeting organizer. In an example, the electronic invitation is sent to email addresses of each of the invitees. A computing device operated by an invitee may present the electronic invitation on a display, and the computing device may receive input of whether or not the invitee accepts the electronic invitation. Additionally, transmission of the electronic invitation may cause the graph application to update the user graph and/or the tenancy graph to include a node representing the meeting.

Subsequently, it is contemplated that the meeting occurs between at least some of the invitees at the start datetime specified in the electronic invitation for the meeting. In an example, the meeting organizer, a first invitee (now referred to as a first attendee), and a second invitee (now referred to a second attendee) attend the meeting. With more specificity, the meeting organizer, the first attendee, and the second attendee may communicate with one another via respective computing devices using video-based communication, audio-based communication, text-based communication, or a combination thereof. Occurrence of the meeting causes the meeting application to generate data, which is utilized to update (i.e., modify) the user graph and/or the tenancy graph. Based upon the keyword(s), the identifier for the user, and the updated user graph/tenancy graph, the AI personalization application obtains an identifier for one or more tasks, and causes a notification of the one or more tasks to be sent to an electronic account with an individual that is to complete the one or more tasks, where the one or more tasks pertain to the meeting and are completed are to be completed after occurrence of the meeting. For instance, if the meeting organizer opts-in, the meeting application generates a computer-readable transcript of the meeting. Subsequent to occurrence of the meeting, the graph application updates the user graph and/or the tenancy graph based upon the transcript. With more specificity, the graph application may update the node representing the meeting in the user graph and/or the tenancy graph based upon the transcript. The AI personalization application may apply natural language processing (NLP) techniques on the updated user graph/tenancy graph in order to obtain identifiers for tasks that are to be completed subsequent to occurrence of the meeting. The AI personalization application may also obtain, via the user graph and/or the tenancy graph, identifiers for content that is likely to be relevant in completing the tasks and/or identifiers for individuals (e.g., attendees of the meeting) that can be assigned the tasks. The AI personalization application may transmit notifications of the tasks to electronic accounts of individuals that are to complete the tasks, where the notifications may include the relevant content.

According to other embodiments, the AI personalization application obtains the identifiers for the one or more invitees or potential invitees for the meeting and/or identifiers for computer-readable content that is to be or that may be included in an electronic invitation for the meeting based upon a vector representation of the user graph and/or the tenancy graph. With more specificity, the graph application may generate a vector representation of the user graph and/or the tenancy graph. The AI personalization application generates a vector representation of the keyword and searches the vector representation of the user graph and/or the tenancy graph in order to obtain the identifiers for the invitees or the potential invitees to the meeting and/or identifiers for the content that is to be or that may be included in the electronic invitation. The AI personalization application may identify follow-up tasks for the meeting and the content that is relevant to completing the follow-up tasks using the vector representation of the user graph and/or the tenancy graph and the vector representation of the keyword as well.

The above-described technologies present various technical advantages over conventional technologies pertaining to meeting organization via computer-executable applications. Unlike conventional technologies, the AI personalization application described above is not limited to identifying invitees and/or content based upon a most recently accessed list and/or a most frequently accessed list. Rather, the AI personalization application utilizes a user graph and/or one or more tenancy graphs for the user to automatically identify invitees to a meeting and/or automatically identify content that is to be included in an electronic invitation to the meeting. Furthermore, the AI personalization application reduces the computational burden on a computing device operated by the user, as the computing device does not need to receive extensive input in order to manually locate the content that is to be included in the electronic invitation.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an example computing environment that facilitates artificial intelligence (AI) driven personalization for electronic meeting creation and follow-up.

FIG. 2 is a functional block diagram of an example processing engine of an AI personalization application.

FIG. 3 is a functional block diagram of an example runtime intelligence engine of an AI personalization application.

FIG. 4 is an illustration of an example user graph.

FIG. 5 is an illustration of an example tenancy graph.

FIG. 6 depicts an example graphical user interface (GUI) that facilitates AI driven personalization for electronic meeting creation.

FIG. 7A-B depict example GUIs that facilitate AI driven personalization for electronic meeting follow-up.

FIG. 8 is a flow diagram that illustrates an example methodology executed by a computing system that facilitates AI driven personalization for electronic meeting creation.

FIG. 9 is a flow diagram that illustrates an example methodology executed by a computing device operated by a user that facilitates AI driven personalization for electronic meeting creation and follow-up.

FIG. 10 is a flow diagram that illustrates an example methodology executed by a computing system that facilitates AI driven personalization for electronic meeting follow-up.

FIG. 11 is an example computing device.

### DETAILED DESCRIPTION

Various technologies pertaining to artificial intelligence (AI) driven personalization for electronic meeting creation and follow-up are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Disclosed herein are various technologies pertaining to artificial intelligence (AI) driven personalization for electronic meeting creation and follow-up. With more specificity, an AI personalization application is disclosed herein that is configured to identify invitees for an electronic meeting and computer-readable content that is to be included in an electronic invitation for the meeting. The invitees and the content for the meeting are obtained via a computer-implemented user graph for a user (i.e., a meeting organizer), and optionally, a computer-implemented tenancy graph belonging to a tenancy (e.g., a group, an organization, etc.) of the user. The AI personalization application is also configured to identify follow-up tasks that are to be completed after occurrence of the meeting via the user graph, and optionally, the tenancy graph.

For example, if a user (e.g., a meeting organizer) opts-in, a graph application obtains (i.e., receives or generates) user activity data of the user from a plurality of applications and generates and maintains a user graph for the user based upon the user activity data. The user activity data may include historical activity data of the user and/or real-time data of the user collected via a plugin or interop communication. The user graph includes nodes and edges connecting the nodes. Each node represents an entity, where the entity may be a contact of the user (i.e., a different user), a topic, content (e.g., an email, a slideshow presentation, etc.) that has been associated with (e.g., created by, edited by, accessed by, able to be accessed by, and/or viewed by) the user, a commitment of the user (e.g., a meeting that the user has attended or will attend), or a tenancy of the user (e.g., a group or an organization to which the user belongs). Each edge is assigned criteria that is indicative of a relationship between entities represented by nodes that are connected by a respective edge. In an example, when an email application transmits an email authored by the user to a contact of the user, the graph application identifies at least one seed node in the user graph representing a topic that has been assigned to the email (or a subtopic of the email, or a related topic to the topic of the email, or a name of a person referenced in the email, or the like). In the example, the graph application generates a second level node representing the email. The second level node may include metadata for the email. The graph application also generates a first edge that connects the seed node(s) to the second level node, where the first edge is assigned criteria that indicates that the email belongs to the topic. Following the example, the graph application may also identify a third level node in the user graph representing the contact of the user. The graph application also generates a second edge and connects the second level node to the third level node via the second edge. In this example, the second edge is assigned second criteria indicating that the email was sent by the user to the contact of the user.

In some embodiments, the graph application also generates and maintains a tenancy graph for a tenancy to which the user belongs (e.g., a group, a team, or an organization). The tenancy graph is similar to the user graph, that is, the tenancy graph has nodes representing entities and edges connecting the nodes. Each edge is assigned criteria that is indicative of a relationship between entities represented by nodes that are connected by a respective edge. However, unlike the user graph, nodes representing content in the tenancy graph represent content that is associated with the tenancy and that is accessible to the user, but that may or may not have been previously accessed by the user. For this reason, the tenancy graph may include nodes and edges (e.g., representing topics) that are not represented in the user graph and vice versa.

A meeting surface application receives an indication that the user (i.e., the meeting organizer) wishes to schedule a meeting (e.g., a meeting that occurs over a network connection between at least two individuals utilizing respective instances of a meeting application). According to some embodiments, the meeting surface application is part of the meeting application. According to other embodiments, the meeting surface application is separate from the meeting application.

The meeting surface application receives one or more keywords that pertain to the meeting. According to some embodiments, the one or more keywords are a title for the meeting that is received as input from the user. According to other embodiments, the one or more keywords are a title of computer-readable content that is selected by the user on a display. The AI personalization application can obtain (i.e., generate or receive) the one or more keywords and an identifier for the user. For instance, the meeting surface application transmits the one or more keywords and the identifier for the user to the AI personalization application.

Based upon the one or more keywords and the identifier for the user, the AI personalization application obtains identifiers for one or more invitees (or potential invitees) for the meeting and/or identifiers for computer-readable content that is to be (or that may be) included in an electronic invitation for the meeting via the user graph for the user. With more specificity, according to some embodiments, the AI personalization application identifies a topic based upon the one or more keywords. The AI personalization application also identifies the user graph for the user (from amongst a plurality of graphs) based upon the identifier for the user. The AI personalization application then walks the user graph based on the topic in order to identify a subgraph for the topic. With more specificity, the AI personalization application identifies at least one node in the user graph that represents the topic (i.e., at least one seed node). The AI personalization application then traverses edges that connect the seed node(s) to reach second level nodes in the user graph (“a first level of expansion”). In an example, the second level nodes represent contacts of the user. As the second level nodes are connected to the at least one node via at least one edge, the meeting may be relevant to some or all of the contacts, and some or all of the contacts are invitees or potential invitees for the meeting. For each second level node (or for selected second level nodes of a given type), the AI personalization application may traverse edges connecting the second level nodes to third level nodes (“a second level of expansion”). In an example, the third level nodes represent computer-readable content (e.g., documents, emails, spreadsheets, video files, etc.) that are relevant or potentially relevant to the meeting. Alternatively, the second level of expansion may identify the computer-readable content and the third level of expansion may identify the invitees. This process may continue until the AI personalization application reaches a threshold level of expansion (e.g., three levels of expansion), whereupon the subgraph identification is completed. According to some embodiments, based upon the one or more keywords and the identifier for the user, the AI personalization application also performs a walk of one or more tenancy graphs of the user based on the topic in order to identify one or more additional subgraphs for the topic. The AI personalization application may utilize transitive closure graph properties in order to optimize generation of the subgraph(s).

According to some embodiments, the potential invitees and/or the potentially relevant content identified via the user graph and/or the tenancy graph are ranked, and invitees and/or content that is ranked above a threshold level (e.g., top three, top five, etc.) are automatically included in the electronic invitation for the meeting. According to other embodiments, the AI personalization application causes a list of the potential invitees and/or a list of the potentially relevant content to be displayed within a graphical user interface (GUI) for the meeting surface application. The AI personalization application may rank (e.g., based on suitable criteria) the potential invitees in the list such that potential invitees that are likely to be required to attend the meeting are presented to the user at a beginning of the list. The user examines the list of the potential invitees and the meeting surface application receives, from the user, a selection of one or more invitees that are to be invited to the meeting. The user also examines the list of the potentially relevant content and the meeting surface application receives, from the user, a selection of content that is to be included in the electronic invitation for the meeting. The AI personalization application may rank (e.g., based on suitable criteria) the potentially relevant content in the list of the potentially relevant content such that potentially relevant content that is likely to be required for the meeting is presented to the user at a beginning of the list.

It is to be understood that selection of invitees for the meeting and/or selection of content that is to be included in the electronic invitation may cause the AI personalization application to generate further subgraphs from which the AI personalization application obtains further invitees or potential invitees and/or further relevant content or further potentially relevant content therefrom. Subsequent to presenting identifiers for content that may be included in the electronic invitation, the meeting surface application may receive a selection of an identifier for a particular piece of content (e.g., a document). The meeting surface application may transmit the identifier for the particular piece of content to the AI personalization application. Using processes similar to those set forth above, the AI personalization application may perform a walk of the tenancy graph of the user to identify second invitees or potential invitees and/or second relevant content or second potentially relevant content. The AI personalization application may transmit identifiers for the second invitees or potential invitees and/or identifiers for the second relevant content or second potentially relevant content to the meeting surface application, where the meeting surface application may present such identifiers within the GUI. In this manner, the AI personalization application may identify invitees to the meeting and/or content that is to be included in the electronic invitation, even when the invitees are not contacts of the user and/or the content has not been accessed by the user.

The meeting surface application may also receive a start datetime and an end datetime for the meeting. The meeting surface application causes the electronic invitation for the meeting to be transmitted to electronic accounts of each of the invitees identified in the electronic invitation (some or all of which have been identified via the user graph and/or the tenancy graph), where the electronic invitation includes a title of the meeting, identifiers for invitees of the meeting, attachments and/or links to content that is relevant to the meeting (some or all of which have been identified via the user graph and/or the tenancy graph), the start datetime, the end datetime, and optionally comments set forth by the meeting organizer. In an example, the electronic invitation is sent to email addresses of each of the invitees. A computing device operated by an invitee may present the electronic invitation on a display, and the computing device may receive input of whether or not the invitee accepts the electronic invitation. Additionally, transmission of the electronic invitation may cause the user graph and/or the tenancy graph to be updated to include a node representing the meeting.

Subsequently, it is contemplated that the meeting occurs between at least some of the invitees at the start datetime specified in the electronic invitation for the meeting. In an example, the meeting organizer, a first invitee (now referred to as a first attendee), and a second invitee (now referred to as a second attendee) attend the meeting. With more specificity, the meeting organizer, the first attendee, and the second attendee may communicate with one another via respective computing devices using video-based communication, audio-based communication, text-based communication, or a combination thereof. Occurrence of the meeting causes the meeting application to generate data, which is utilized to update (i.e., modify) the user graph and/or the tenancy graph. Based upon the keyword(s), the identifier for the user, and the updated user graph/tenancy graph, the AI personalization application obtains an identifier for one or more tasks that are to be completed subsequent to the meeting, and causes a notification of the one or more tasks to be sent to an electronic account with an individual that is to complete the one or more tasks. For instance, if the meeting organizer opts-in, the meeting application generates a computer-readable transcript of the meeting. Subsequent to occurrence of the meeting, the graph application updates the user graph and/or the tenancy graph based upon the transcript. With more specificity, the graph application may update the node representing the meeting in the user graph and/or the tenancy graph based upon the transcript. The AI personalization application may apply natural language processing (NLP) techniques on the updated user graph/tenancy graph in order to obtain identifiers for tasks that are to be completed subsequent to occurrence of the meeting. The AI personalization application may also obtain, via the user graph and/or the tenancy graph, identifiers for content that is likely to be relevant in completing the tasks and/or identifiers for individuals (e.g., attendees of the meeting) that can be assigned the tasks. The AI personalization application may transmit notifications of the follow-up tasks to electronic accounts of individuals that are to complete the tasks, where the notifications may include the relevant content.

According to other embodiments, the AI personalization application obtains the identifiers for the one or more invitees or potential invitees for the meeting and/or identifiers for computer-readable content that is to be or that may be included in an electronic invitation for the meeting based upon a vector representation of the user graph and/or the tenancy graph. With more specificity, the graph application may generate a vector representation of the user graph and/or the tenancy graph. The AI personalization application generates a vector representation of the keyword and searches the vector representation of the user graph and/or the tenancy graph in order to obtain the identifiers for the invitees or the potential invitees to the meeting and/or identifiers for the content that is to be or that may be included in the electronic invitation. The AI personalization application may and identify the follow-up tasks for the meeting and the content that is relevant to completing the tasks using the vector representation of the user graph and/or the tenancy graph and the vector representation of the keyword as well.

The above-described technologies present various technical advantages over conventional technologies pertaining to meeting organization via computer-executable applications. Unlike conventional technologies, the AI personalization application described above is not limited to identifying invitees and/or content based upon a most recently accessed list and/or a most frequently accessed list. Rather, the AI personalization application utilizes a user graph and/or one or more tenancy graphs for the user to automatically identify invitees to a meeting and/or automatically identify content that is to be included in an electronic invitation to the meeting. Furthermore, the AI personalization application reduces the computational burden on a computing device operated by the user, as the computing device does not need to receive extensive input in order to manually locate the content that is to be included in the electronic invitation.

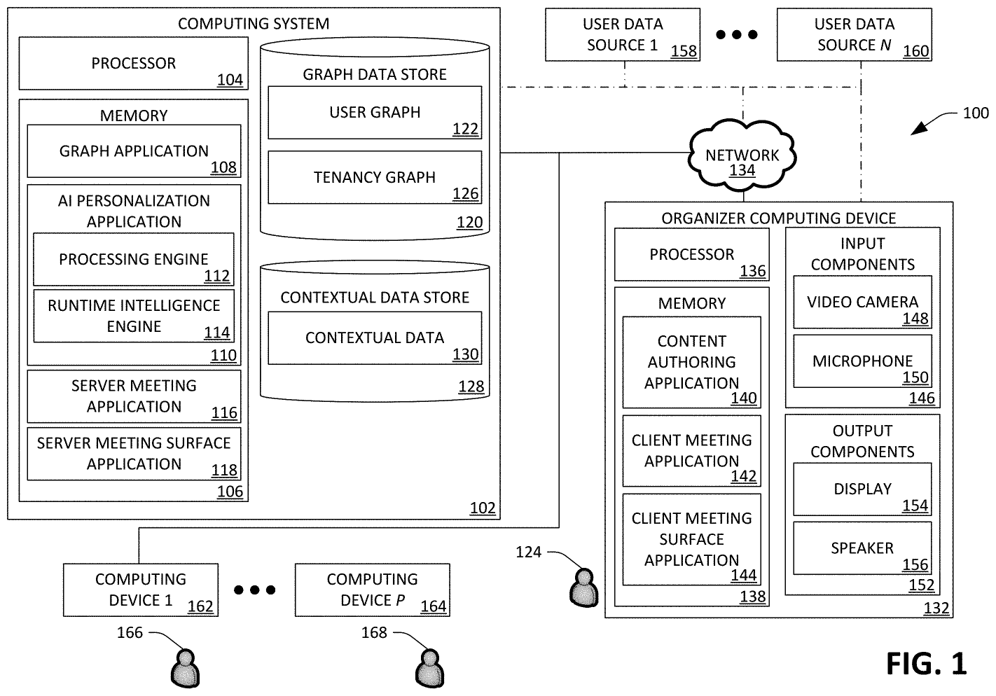

With reference to FIG. 1, an example computing environment 100 that facilitates AI driven personalization for electronic meeting creation and follow-up is illustrated. The computing environment 100 includes a computing system 102. In some embodiments, the computing system 102 may be or include a cloud computing service. The computing system 102 includes a processor 104 and memory 106. The memory 106 has a graph application 108 and an AI personalization application 110 loaded therein. As will be described in greater detail below, the graph application 108, when executed by the processor 104, is configured to obtain (e.g., receive or generate) user activity data from a plurality of applications and to generate and maintain user graphs for the users based upon the user activity data. The user activity data may include historical activity data and/or real-time data collected via a plugin or interop communication. In some embodiments, the graph application 108 is also configured to generate tenancy graphs.

The AI personalization application 110, when executed by the processor 104, is configured to identify invitees that may be invited to a meeting based upon data obtained or derived from user graphs and/or tenancy graphs (described in greater detail below). The AI personalization application 110 is also configured to identify relevant content (e.g., documents) that may be included in an electronic invitation for the meeting based upon the user graphs and/or the tenancy graphs. The AI personalization application 110 is further configured to identify, based upon the user graphs and/or the tenancy graphs, tasks that are to be completed by individuals subsequent to occurrence of the meeting and content that is relevant to the tasks. The AI personalization application 110 may include a processing engine 112 and a runtime intelligence engine 114.

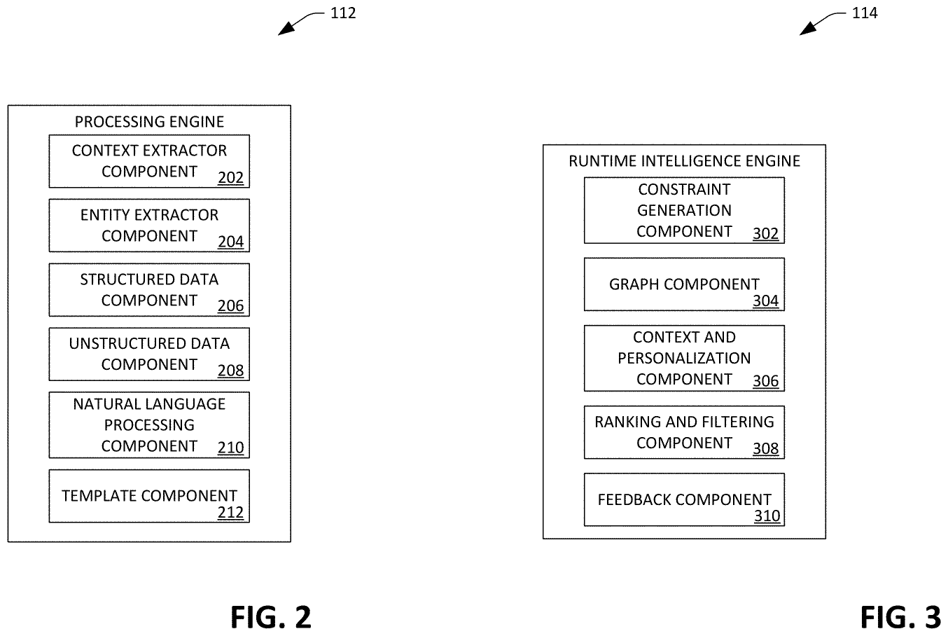

Turning briefly now to FIG. 2, a functional block diagram of the processing engine 112 is illustrated. In general, the processing engine 112 is configured to perform walks of user graphs (and optionally tenancy graphs) in order to identify entities that are relevant to users. The processing engine 112 is also configured to perform processing on the entities (e.g., content) represented in the user graphs (and optionally the tenancy graphs) in order to identify and/or derive contextual data from the entities. The processing engine 112 includes a context extractor component 202, an entity extractor component 204, a structured data component 206, an unstructured data component 208, a natural language processing (NLP) component 210, and a template component 212 (collectively referred to herein as “the processing engine components 202-212”). The context extractor component 202 is configured to extract contexts from content represented in user graphs and/or tenancy graphs. The entity extractor component 204 is configured to extract entities from the content represented in the user graphs and/or the tenancy graphs. The entity extractor component 204 may identify different entities referenced in a document, different users referenced in the document, and so forth. The structured data component 206 is configured to identify and extract structured data included in the content represented in the user graphs and/or the tenancy graphs. The unstructured data component 208 is configured to identify and extract unstructured data included in the content represented in the user graphs and/or the tenancy graphs. The NLP component 210 is configured to perform NLP (via an NLP algorithm) on text found in content represented in the user graphs and/or the tenancy graphs. The NLP component 210 may generate summaries of documents represented in the user graphs and/or tenancy graphs. The template component 212 is configured to extract information from content represented in the user graphs and/or the tenancy graphs based upon the information in the content matching templates. It is to be understood that each of the processing engine components 202-212 may utilize various AI models and algorithms to perform their respective functionality. The AI models and algorithms may be or include classification models and algorithms or regression models and algorithms. The AI models and algorithms may be or include neural networks, decision trees, support vector machines, Bayesian networks, and so forth. Although the processing engine components 202-212 have been depicted as being implemented on the computing system 102 (i.e., server-side), it is to be understood that some or all of the functionality of the processing engine components 202-212 may be implemented client-side.

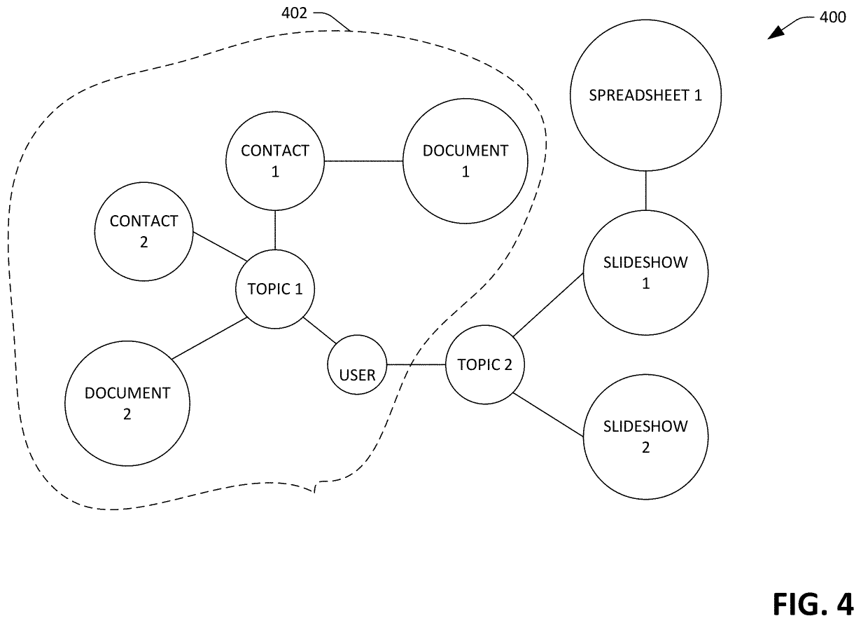

Referring briefly now to FIG. 3, a functional block diagram of the runtime intelligence engine 114 is illustrated. In general, the runtime intelligence engine 114 is configured to identify invitees (or potential invitees) to a meeting and/or identify content (e.g., documents, emails, etc.) that is to be included (or that may be included) in an electronic invitation to the meeting. The runtime intelligence engine 114 includes a constraint generation component 302, a graph component 304, a context and personalization component 306, a ranking and filtering component 308, and a feedback component 310. The constraint generation component 302 is generally configured to generate constraints based upon a keyword, where the constraints are additional keywords that are utilized (in addition to the keywords) to identify invitees (or potential invitees) to the meeting and/or content (or potential content). In an example, a constraint is a word that is similar to the keyword, a phrase, an identifier for an invitee that has been identified as being included in the electronic invitation, an identifier for content that has been identified as being included in the electronic invitation, and/or a title of the meeting. The graph component 304 is generally configured to perform walks of user graphs and/or tenancy graphs (described in greater detail below). The context and personalization component 306 is generally configured to obtain personalized information for a meeting organizer. The personalized information may include identifiers for invitees (or potential invitees) to the meeting, identifiers for content that is to be included (or that may potentially be included) in the electronic invitation to the meeting, identifiers for tasks that are to be completed subsequent to occurrence of the meeting, and identifiers for content that is relevant to the tasks. The ranking and filtering component 308 is generally configured to rank the personalized information and/or filter duplicative information. When the context and personalization component 306 has obtained an identifier for a first potential invitee to the meeting and an identifier for a second potential invitee, the ranking and filtering component 308 may rank the first potential invitee and the second potential invitee based upon suitable criteria, such as the user activity data and/or distances of nodes representing each invitee from a topic node, and the identifier for the first potential invitee and the identifier for the second potential invitee may be presented in an order determined by the ranking. The feedback component 310 configured to receive feedback from users as to whether the personalized information identified by the AI personalization application 110 was relevant. The AI personalization application 110 may update the AI models and algorithms based upon the feedback. It is to be understood that each of the runtime intelligence engine components 302-310 may utilize the AI models and algorithms referenced above to perform their respective functionality. Although the runtime intelligence engine components 302-310 have been depicted as being implemented on the computing system 102 (i.e., server-side), it is to be understood that some or all of the functionality of the runtime intelligence engine components 302-310 may be implemented client-side.

Referring back to FIG. 1, the memory 106 may further include a server meeting application 116. In general, the server meeting application 116, when executed by the processor 104, is configured to facilitate video-based communication, audio-based communication, and/or text-based communication during meetings. The memory 106 may also include a server meeting surface application 118 that, when executed by the processor 104, is configured to enable users to organize and send electronic invitations for meetings (e.g., meetings that occur via the server meeting application 116). The server meeting surface application 118 may be part of the server meeting application 116 or the server meeting surface application 118 may be a separate application (e.g., an email application) that communicates with the server meeting application (and clients) in order to organize meetings. Although the server meeting application 116 and the server meeting surface application 118 are depicted in FIG. 1 as executing on the computing system 102, it is to be understood that the server meeting application 116 and the server meeting surface application 118 may execute on different server computing devices.

The computing system 102 further includes a graph data store 120. The graph data store 120 includes a user graph 122 for a user 124. The user graph 122 for the user 124 includes nodes and edges connecting the nodes. Each node represents an entity, where the entity may be the user 124, a topic, content associated with (e.g., created by, edited by, accessed by, able to be accessed by, and/or viewed by) the user 124, a commitment of the user 124 (i.e., a meeting that has occurred or that will occur), another user (e.g., a contact of the user 124), or a tenancy (e.g., a group, a team, or an organization) of the user 124. Thus, the user graph 122 for the user 124 is a heterogenous graph. Nodes in the user graph 122 representing content may include metadata for the content (e.g., an identifier for the content, an identifier for a storage location of the content, a time of creation of the content, etc.). Each edge is assigned criteria that is indicative of a relationship between entities represented by nodes that are connected by a respective edge. In an example, content represented by a node in the user graph 122 is a slideshow presentation, a document, a spreadsheet, an email, or a real-time message. Although the graph data store 120 is depicted as storing a single user graph, it is to be understood that the graph data store 120 may store different user graphs for different users.

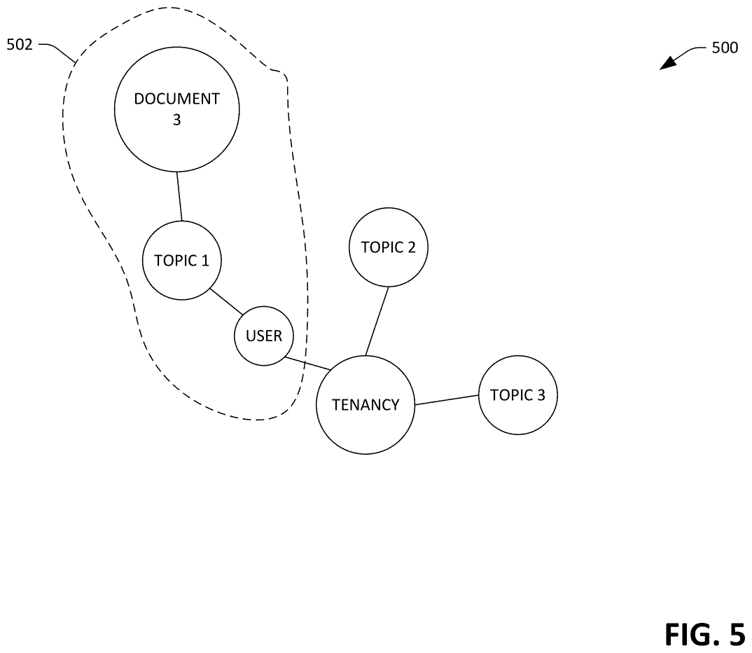

Referring briefly now to FIG. 4, an example user graph 400 is depicted. The user graph 400 may be the user graph 122. As illustrated in FIG. 4, the user graph 400 includes nodes (represented in FIG. 4 as circles) and edges connecting the nodes (represented in FIG. 4 as straight lines). Each edge in the edges of the user graph 400 is assigned criteria that is indicative of a relationship between entities represented by nodes that are connected by a respective edge. In an example, an edge connecting a node representing topic 1 to a node representing document 2 may be assigned criteria indicating that document 2 pertains to topic 1. As will be described in greater detail below, the AI personalization application 110 identifies subgraphs of user graphs in order to provide personalized electronic meeting creation and follow-up functionality. In the example shown in FIG. 4, the AI personalization application 110 has identified a subgraph 402 of the user graph 400 centered around a node representing topic 1. It is to be understood that the AI personalization application 110 may create many different subgraphs, and such subgraphs may be centered around topics, different users, different content, and so forth.

Referring back to FIG. 1, in some embodiments, the graph data store 120 may also include a tenancy graph 126. The tenancy graph 126 is similar to the user graph 122. For instance, the tenancy graph 126 includes nodes and edges connecting the nodes. Each node in the tenancy graph 126 represents an entity, where the entity may be a topic, content of the tenancy, a commitment of the tenancy, different users of the tenancy, etc. However, unlike the user graph 122, nodes representing content in the tenancy graph 126 represent content that is associated with the tenancy and that is accessible to the user 124, but that may or may not have been previously accessed by the user 124. For this reason, the tenancy graph 126 may include nodes (e.g., representing topics) and edges that are not represented in the user graph 122 and vice versa. Although not depicted in FIG. 1, it is to be understood that the user 124 may belong to more than one tenancy, and hence, the graph data store 120 may store a tenancy graph for each tenancy to which the user 124 belongs (as well as tenancy graphs for tenancies to which the user 124 does not belong).

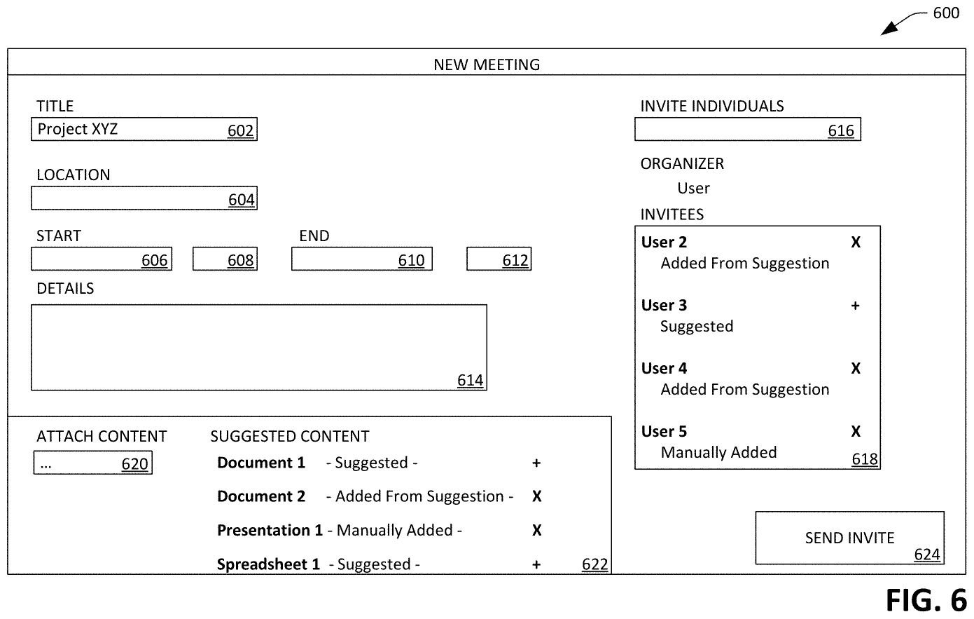

Turning briefly to FIG. 5, an example tenancy graph 500 is depicted. The tenancy graph 500 may be the tenancy graph 126. As illustrated in FIG. 5, the tenancy graph 500 includes nodes (represented in FIG. 5 as circles) and edges connecting the nodes (represented in FIG. 5 as straight lines). Each edge in the edges of the tenancy graph 500 is assigned criteria that is indicative of a relationship between entities represented by nodes that are connected by a respective edge. In an example, an edge connecting a node representing topic 1 to a node representing document 3 may be assigned criteria indicating that document 3 pertains to topic 1. As will be described in greater detail below, the AI personalization application 110 identifies subgraphs of tenancy graphs in order to provide personalized electronic meeting creation and follow-up functionality. In the example shown in FIG. 5, the AI personalization application 110 has identified a subgraph 502 of the tenancy graph 500 centered around a node representing topic 1. It is to be understood that the AI personalization application 110 may create many different subgraphs of tenancy graphs, and such subgraphs may be centered around topics, different users, different content, and so forth.

Referring back to FIG. 1, the computing system 102 may additionally include a contextual data store 128. The contextual data store 128 includes contextual data 130 for the user 124. The AI personalization application 110 may store the contextual data 130 for the user 124 in the contextual data store 128 based upon a walk (and subsequent processing) of the user graph 122 for the user 124. The contextual data 130 for the user 124 may include content (represented by at least one node in the user graph 122) of the user 124, a portion of the content (represented by at least one node in the user graph 122) of the user 124, and/or data that has been derived from the content (represented by at least one node in the user graph 122) of the user 124 via the processing engine 112. In some embodiments, the contextual data 130 for the user 124 may also be based upon a walk (and subsequent processing) of the tenancy graph 126. The contextual data 130 may include identifiers for invitees (or potential invitees) to a meeting, identifiers for content that is to be or that may be attached to an electronic invitation for the meeting, identifiers for tasks that are to be completed subsequent to occurrence of the meeting, and/or identifiers for content that is relevant to completing the tasks. According to some embodiments, at least some of the identifiers for the invitees (or the potential invitees), the identifiers for the content that is included in (or that may be included in) the electronic invitation for the meeting, the identifiers for the tasks, and the identifiers for the content that is relevant to completing the tasks stored in the contextual data store 128 as part of the contextual data 130 are pre-computed based upon user activity data for users such that such information is able to be retrieved at run-time.

The computing environment 100 additionally includes an organizer computing device 132 operated by the user 124. In an example, the organizer computing device 132 is a desktop computing device, a laptop computing device, a tablet computing device, a smartphone, etc. The organizer computing device 132 may be in communication with the computing system 102 by way of a network 134 (e.g., the Internet, intranet, etc.). According to some embodiments where the computing system 102 is a server computing device, the organizer computing device 132 may be a client computing device. The organizer computing device 132 includes a processor 136 and memory 138, where the memory 138 may have a content authoring application 140 loaded therein. In general, the content authoring application 140 is designed to generate content. The content authoring application 140 may be or include a slideshow application, a word processing application, a spreadsheet application, an email application, and/or a real-time messaging application. As such, the content generated and/or presented by the content authoring application 140 may be or include a slideshow presentation, a document, a spreadsheet, an email, and/or a real-time message.

The memory 138 includes a client meeting application 142 that, when executed by the processor 136, is configured to enable the user 124 to engage in real-time communication with one or more individuals over a network connection (e.g., the network 134) during electronic meetings. The real-time communication may include video-based communication, audio-based communication, text-based communication, or a combination thereof. The client meeting application 142 may be considered to be a content authoring application. According to some embodiments, the client meeting application 142 communicates with the server meeting application 116 in order to communicate with other client meeting applications during electronic meetings. According to other embodiments, the client meeting application 142 establishes direct connections with other client applications during electronic meetings.

The memory 138 may further include a client meeting surface application 144. The client meeting surface application 144, when executed by the processor 136, is generally configured to enable the user 124 to generate electronic invitations for meetings and to transmit the electronic invitations to electronic accounts of invitees to the meeting. According to some embodiments, the client meeting surface application 144 is an email application and/or a calendar application. The client meeting surface application 144 may be considered to be a content authoring application. According to some embodiments, the client meeting surface application 144 communicates with the server meeting surface application 118 in order to generate and transmit the electronic invitations. According to other embodiments, the client meeting surface application 144 transmits the electronic invitations directly to electronic accounts of the invitees. According to some embodiments, functionality of the client meeting surface application 144 is incorporated into the client meeting application 142, and as such it is to be understood that the client meeting surface application 144 is optional in such embodiments.

The organizer computing device 132 further includes input components 146 that enable the organizer computing device 132 to receive input from the user 124. The input components 146 may receive input from the user 124 during a meeting in order for the user 124 to communicate with attendees of the meeting. The input components 146 include a video camera 148 and a microphone 150. The input components 146 may also include a mouse, a keyboard, a trackpad, a scroll wheel, a camera, etc. The organizer computing device 132 also includes output components 152 that enable data to be presented to the user 124. The output components 152 may present audio and video to the user 124 during a meeting in order for the other attendees of the meeting to communicate with the user 124. The output components 152 include a display 154, whereupon graphical features may be presented thereon. A graphical user interface (GUI) for the content authoring application 140, the client meeting application 142, and/or the client meeting surface application 144 may be presented on the display 154. The output components 152 may also include a speaker 156. The output components 152 may also include other components, such as a haptic feedback device (not depicted in FIG. 1).

The computing environment 100 further includes a first user data source 158 that stores data of the user 124. The first user data source 158 may store the content generated by the content authoring application 140, content generated by other content authoring applications, or other data associated with the user 124. The first user data source 158 may store a slideshow presentation, a document, a spreadsheet, an email, a real-time message, a video recording, and/or an audio recording. The computing environment 100 may also include an Nth user data source 160 that also stores content generated by the content authoring application 140, content generated other content authoring applications, or other data associated with the user 124, where N is a positive integer greater than one. The first user data source 158 and the Nth user data source 160 are collectively referred to herein as “the plurality of user data sources 158-160.” Although the plurality of user data sources 158-160 are depicted in FIG. 1 as being external to the computing system 102 and the organizer computing device 132, other possibilities are contemplated. The plurality of user data sources 158-160 may include a data source that is part of the organizer computing device 132 (i.e., local storage), a data source that is part of another computing device of the user 124, a data source that is part of the computing system 102, a data source that is part of a cloud computing service, a data source that is part of a server computing device (not illustrated in FIG. 1), or a combination thereof.

The computing environment 100 may further include a first computing device 162 and a Pth computing device 164 operated by a first user 166 and a Pth user 168, respectively, where P is a positive integer greater than 1 (collectively referred to as “the plurality of computing devices 162-164”). The plurality of computing devices 162-164 include components similar to or identical to the organizer computing device 132. The plurality of computing devices 162-164 are in communication with the computing system 102 and/or the organizer computing device 132 by way of the network 134. The plurality of computing devices 162-164 include respective instances of a client meeting application that enable the first user 166 and the Pth user 168 to engage in video-based communication, audio-based communication, and/or textual-based communication over the network 134 during a meeting.

Referring now to FIG. 1, operation of the computing environment 100 is now set forth. If the user 124 opts-in, the graph application 108 obtains (i.e., receives or generates) user activity data of the user 124 from a plurality of applications and generates and maintains the user graph 122 for the user 124 based upon the user activity data. The user activity data may include historical activity data of the user 124 and/or real-time data of the user 124 collected via a plugin or interop communication. With more specificity, when an application in the plurality of application accesses content for the user 124, the graph application 108 identifies at least one topic of the content (e.g., using AI models and algorithms). Upon identifying the topic(s), the graph application 108 identifies at least one seed node in the user graph 122 representing the topic(s). In the event that a node representing the topic(s) does not exist in the user graph 122, the graph application 108 generates the seed node and adds it to the user graph 122. The graph application 108 also generates a second level node representing the content. The second level node representing the content may include metadata for the content. The metadata may include an identifier for the content, an identifier for a user data source in the plurality of user data sources 158-160 that stores the content, a time of creation of the content, etc. The graph application 108 then connects the seed node(s) to the second level node representing the content via at least one edge, where the graph application 108 assigns the edge with criteria that is indicative of a relationship between the seed node and the second level node. It is to be understood that the graph application 108 may connect second level node to many different nodes in the user graph 122 via different edges. The second level node may be connected to a node representing a contact of the user 124 (i.e., a third level node) via a second edge, where the contact of the user 124 contributed to the content. Additionally or alternatively, the second level node may be connected to a second seed node that represents a different topic.

In some embodiments, the graph application 108 also generates and maintains the tenancy graph 126 for the tenancy of the user 124. The tenancy graph 126 is similar to the user graph 122 for the user 124. For instance, the tenancy graph 126 includes nodes representing entities and edges connecting the nodes. Each edge is assigned criteria that is indicative of a relationship between entities represented by nodes that are connected by a respective edge. However, unlike the user graph 122 for the user 124, nodes representing content in the tenancy graph 126 represent content that is associated with the tenancy and that is accessible to the user 124, but which the user 124 may or may not have accessed.

The client meeting surface application 144 receives an indication that the user 124 (i.e., the meeting organizer) wishes to schedule a meeting. The meeting may be a meeting that is to occur over the network 134 between at least two individuals (e.g., the user 124 and at least one of the plurality of users 166-168) via respective instances of the client meeting application, a meeting that is to occur in person between at least two individuals (while at least one instance of the meeting application is executing on a computing device in the presence of the at least two individuals during the meeting), or a meeting that is to occur partly over the network 134 and partly in person between at least three individuals (e.g., the user 124 attends the meeting over a network connection while the first user 166 and the Pth user 168 attend the meeting in person together with one another while communicating with the user 124 via one or more instances of the client meeting application).

The client meeting surface application 144 receives one or more keywords that pertain to the meeting. According to some embodiments, the one or more keywords are a title for the meeting that is received as input from the user 124. According to other embodiments, the one or more keywords are a title of computer-readable content that is selected by the user 124. The AI personalization application 110 can obtain (i.e., generate or receive) the one or more keywords and an identifier for the user 124. For instance, the client meeting surface application 144 transmits the one or more keywords and the identifier for the user 124 to the AI personalization application 110.

Based upon the keyword(s) and the identifier for the user 124, the AI personalization application 110 obtains identifiers for one or more invitees or potential invitees to the meeting and/or identifiers for computer-readable content that is to be or that may be included in an electronic invitation for the meeting via the user graph 122 for the user 124. With more specificity, according to some embodiments, the AI personalization application 110 identifies a topic based upon the one or more keywords. The AI personalization application 110 also identifies the user graph 122 for the user 124 (from amongst a plurality of graphs) based upon the identifier for the user 124. The AI personalization application 110 then walks the user graph 122 based on the topic in order to identify a subgraph for the topic. With more specificity, the AI personalization application 110 identifies at least one node in the user graph 122 that represents the topic (i.e., at least one seed node). The AI personalization application 110 then traverses edges that connect the seed node(s) to reach second level nodes in the user graph 122 (“a first level of expansion”). In an example, the second level nodes represent contacts of the user 124. As the second level nodes are connected to the at least one node via at least one edge, the meeting may be relevant to some or all of the contacts, and some or all of the contacts are (potential) invitees for the meeting. For each second level node (or for selected second level nodes of a given type), the AI personalization application 110 may traverse edges connecting the second level nodes to third level nodes (“a second level of expansion”). In an example, the third level nodes represent computer-readable content (e.g., documents, emails) that are (potentially) relevant to the meeting. Alternatively, the second level of expansion may identify the (potentially) relevant computer-readable content and the third level of expansion may identify the potential invitees. It is to be understood that levels of expansion may include different types of nodes. For instance, a level of expansion may identify a combination of computer-readable content and potential invitees. This process may continue until the AI personalization application 110 reaches a threshold level of expansion (e.g., three levels of expansion), whereupon the subgraph identification is completed.

According to some embodiments, the AI personalization application 110 also performs a walk of the tenancy graph 126 based on the topic in order to identify one or more additional subgraphs for the topic. The AI personalization application 110 may identify a tenancy of the user 124 based upon the identifier for the user 124 and the keyword, optionally, access control information for the user 124. Based upon the identifier for the user 124 and the keyword, the AI personalization application 110 may obtain identifiers for second invitees or second potential invitees via the tenancy graph 126. Additionally, based upon the identifier for the user 124 and the keyword, the AI personalization application 110 may obtain identifiers for second content that is to be or that may be included in the electronic invitation via the tenancy graph 126. The AI personalization application may cause the identifiers for the second invitees and/or the second content to be included in the electronic invitation. According to some embodiments, the walk of the user graph 122 and/or the tenancy graph 126 may be optimized based upon transitive closure properties of graphs.

According to some embodiments, the AI personalization application 110 ranks the potential invitees and/or the potentially relevant content, and identifiers for invitees and/or content that are ranked above a threshold level (e.g., top three, top five, top ten, etc.) are automatically included in the electronic invitation for the meeting. According to other embodiments, the AI personalization application 110 causes identifiers for the potential invitees and/or identifiers for the potentially relevant content to be displayed within a graphical user interface (GUI) for the client meeting surface application 144 shown on the display 154. The AI personalization application 110 may rank the potential invitees such that potential invitees that are likely to be required to attend the meeting are presented to the user at a beginning of a list that includes the potential invitees. The AI personalization application 110 may rank the potentially relevant content such that potentially relevant content that is likely to be required for the meeting is presented to the user 124 at a beginning of a list that includes the potentially relevant content. The user 124 examines the identifiers for the potential invitees and the client meeting surface application 144 receives, from the user 124, a selection of invitees that are to be invited to the meeting. The user 124 also examines the identifiers for the potentially relevant computer-readable content and the client meeting surface application 144 receives, from the user 124, a selection of content that is to be included in or linked to within the electronic invitation.

It is to be understood that selection of invitees for the meeting and/or content that is to be included in the electronic invitation may cause the AI personalization application 110 to generate further subgraphs which the AI personalization application 110 obtains further invitees or potential invitees and/or further relevant content or potentially relevant content therefrom. Subsequent to presenting identifiers for potential invitees to the meeting within the GUI, the client meeting surface application 144 may receive a selection of an identifier for an invitee. The client meeting surface application 144 may transmit the identifier for the invitee to the AI personalization application 110. Using processes similar to those set forth above, the AI personalization application 110 may perform a walk (based upon the one or more keywords, the identifier for the user 124, and/or the identifier for the invitee) of the tenancy graph 126 of the tenancy to which the user 124) belongs to identify second invitees or potential invitees and/or second relevant content or second potentially relevant content. The AI personalization application 110 may transmit identifiers for the second invitees or second potential invitees and/or the identifiers for the second relevant content or second potentially relevant content to the client meeting surface application 144, where the client meeting surface application 144 may present such identifiers within the GUI shown on the display 154. In this manner, the AI personalization application 110 may identify invitees to the meeting and/or content that is to be included in the electronic invitation, even when the invitees are not contacts of the user 124 and/or the content has not been accessed by the user 124.

According to some embodiments, nodes in the user graph 122 and/or tenancy graph 126 that represent individuals are associated with (e.g., include) information pertaining to skill sets of the individuals, managerial oversight of the individuals (i.e., identifiers for managers of the individuals and identifiers for subordinates of the individuals), and/or diversity of thought/background information of the individuals. As such, the AI personalization application 110, via the user graph 122 and/or the tenancy graph 126, may recommend invitees based upon the information pertaining to the skill sets of the individuals, the managerial oversight of the individuals, and/or the diversity of thought/background information of the individuals. For instance, the AI personalization application 110 receives an indication of a preferred skill set, managerial oversight, and/or diversity of thought/background from the user 124 via the client meeting application 142 and/or the client meeting surface application 144, and the AI personalization application 110 walks the user graph 122 and/or the tenancy graph 126 additionally based upon the preferred skill set, managerial oversight, and/or diversity of thought/background. The invitees (or potential invitees) obtained by the AI personalization application 110 (and subsequently presented to the user 124) may possess some or all of the preferred skill set, managerial oversight, and/or diversity of thought/background.

The client meeting surface application 144 may also receive a start datetime (i.e., a start date and a corresponding time on the start date) and an end date time (i.e., an end date and a corresponding time on the end date) for the meeting. The client meeting surface application 144 causes the electronic invitation for the meeting to be transmitted to electronic accounts of each of the invitees (some or all of which have been identified via the user graph 122 and/or the tenancy graph 126), where the electronic invitation includes a title of the meeting, identifiers for invitees of the meeting, attachments and/or links to content that is relevant to the meeting (some or all of which have been identified via the user graph 122 and/or the tenancy graph 126), the start datetime, the end datetime, and optionally comments set forth by the user 124 (e.g., the meeting organizer). In an example, the electronic invitation is sent to email addresses of each of the invitees. A computing device (e.g., the first computing device 166) operated by an invitee (e.g., the first user 166) may present the electronic invitation on a display, and the computing device may receive input of whether or not the invitee accepts the electronic invitation. The computing device may cause the user 124 to receive an indication (e.g., via the organizer computing device 132) as to whether the invitee has accepted or declined the meeting request. Additionally, the graph application 108 may receive an indication that the electronic invitation for the meeting has been sent, and may update the user graph 122 and/or the tenancy graph 126 accordingly. The graph application 108 may generate a node representing the meeting and cause the node to be included in the user graph 122 and/or the tenancy graph 126.

Subsequently, it is contemplated that the meeting occurs between at least some of the invitees at the start datetime specified in the electronic invitation for the meeting. In an example, the meeting organizer 124, the first user 166 and the Pth user 168 attend the meeting. With more specificity, the meeting organizer 124, the first user 166 and the Pth user 168 may communicate with one another via respective computing devices (e.g., the organizer computing device 132, the first computing device 162, and the Pth computing device 164) using video-based communication, audio-based communication, text-based communication, or a combination thereof. Occurrence of the meeting causes the client meeting application 142 and/or the server meeting application 116 to generate data, which is utilized by the graph application 108 to update the user graph 122 and/or the tenancy graph 126. Based upon the keyword(s), the identifier for the user 124, and the updated user graph 122 and/or tenancy graph 126, the AI personalization application 110 obtains an identifier for one or more tasks that are to be completed subsequent to the meeting, and causes a notification of the one or more tasks to be transmitted to an electronic account of an individual that is to complete the one or more tasks. The AI personalization application 110 may further identify (via the updated user graph 122 and/or tenancy graph 124 and based upon the keyword and the identifier for the user 124) individuals that may complete the one or more tasks. It is to be understood that the individuals may or may not have attended the meeting and that the individuals may or may not have been identified as potential invitees by the AI personalization application 110. The AI personalization application 110 may further identify (via the updated user graph 122 and/or tenancy graph 124 and based upon the keyword and the identifier for the user 124) content that is relevant to the task, where the content may be included in the notification.

For instance, if the user 124 opts-in, the server meeting application 116 and/or the client meeting application 142 generate a computer-readable transcript of the meeting. Subsequent to occurrence of the meeting, the graph application 108 updates the user graph 122 and/or the tenancy graph 126 based upon the transcript. For instance, the graph application 108 updates or creates a node in the user graph 122 and/or the tenancy graph 126 based upon the transcript. The AI personalization application 110 may apply NLP techniques on the updated user graph 122 in order to obtain identifiers for tasks that are to be completed subsequent to the meeting (i.e., follow-up tasks). The AI personalization application 110 may also obtain identifiers for individuals that may complete the tasks via the updated user graph 122 and/or the tenancy graph 126. The AI personalization application 110 may further obtain identifiers for content (e.g., documents) that is relevant to completing the tasks via the updated user graph 122 and/or the tenancy graph 126. The AI personalization application 110 may cause notifications of the tasks to be transmitted to electronic accounts of the individuals that are to complete the tasks, where the notifications may include identifiers for the tasks and the content.

According to some embodiments, the AI personalization application 110 obtains the transcript of meeting and applies NLP techniques to the transcript to identify second one or more keywords from the transcript of the meeting. Based upon the second one or more keywords (and optionally the one or more keywords that were identified as part of the process of identifying the invitees to the meeting and/or the content included in the electronic invitation for the meeting), the AI personalization application 110 obtains, via the user graph 122 and/or the tenancy graph 126, at least one of an identifier for a task, an identifier for an individual that is to complete the task, or an identifier for content that is relevant to (i.e., to be used in) completing the task. For instance, the AI personalization application 100 may walk the user graph 122 and/or the tenancy graph 126 based upon the second one or more keywords in order to identify the at least one the identifier for the task, the identifier for the individual that is to complete the task, or the identifier for content that is relevant to completing the task.

According to some embodiments, nodes in the user graph 122 and/or tenancy graph 126 that represent individuals are associated with (e.g., include) information pertaining to skill sets of the individuals, managerial oversight of the individuals (i.e., identifiers for managers of the individuals and identifiers for subordinates of the individuals), and/or diversity of thought/background information of the individuals. As such, the AI personalization application 110, via the user graph 122 and/or the tenancy graph 126, may recommend individuals to complete the follow-up tasks based upon the information pertaining to the skill sets of the individuals, the managerial oversight of the individuals, and/or the diversity of thought/background information of the individuals. For instance, the AI personalization application 110 receives an indication of a preferred skill set, managerial oversight, and/or diversity of thought/background of the user 124 from the client meeting application 142 and/or the client meeting surface application 144, and the AI personalization application 110 walks the user graph 122 and/or the tenancy graph 126 additionally based upon the preferred skill set, managerial oversight, and/or diversity of thought/background. The individuals that are to (or that may) complete the follow-up tasks obtained by the AI personalization application 110 (and subsequently presented to the user 124) may possess some or all of the preferred skill set, managerial oversight, and/or diversity of thought/background.

According to some embodiments, the AI personalization application 110, via a walk of the user graph 122 and/or the tenancy graph 126, presents a number of results (e.g., identifiers for invitees or potential invitees to the meeting, identifiers for content that is to be or that may be included in an electronic invitation for the meeting, identifiers for follow-up tasks that are to be or that may be completed subsequent to the meeting, identifiers for individuals that are to complete the follow-up tasks or that may complete the follow-up tasks, and/or identifiers for content that is to be used in completing the tasks or that may be used in completing the tasks) to the user 124, where the number of results is based upon the level of expansion of the user graph 122 and/or the tenancy graph 126. The AI personalization application 110 may receive an indication that the user 124 wishes to view more results. Upon receiving the indication, the AI personalization application 110 may walk the user graph 122 and/or the tenancy graph 126 based upon the indication. For instance, the AI personalization application 110 walks the user graph 122 and/or the tenancy graph 126 to a next level of expansion (e.g., level two to level three) in order to identify a second number of results that is greater than the number of results. The AI personalization application 110 then causes the second number of results to be presented to the user 124. Similarly, the AI personalization application 110 may receive an indication that the user 124 wishes to view less results. Upon receiving the indication, the AI personalization application 110 may walk the user graph 122 and/or the tenancy graph 126 based upon the indication. For instance, the AI personalization application 110 walks the user graph 122 and/or the tenancy graph 126 to a previous level of expansion (e.g., level three to level two) in order to identify a third number of results that is less than the number of results. The AI personalization application 110 then causes the third number of results to be presented to the user 124.

According to embodiments, the AI personalization application 110 obtains the identifiers for the one or more invitees or potential invitees for the meeting and/or identifiers for computer-readable content that is to be or that may be included in an electronic invitation for the meeting based upon a vector representation of the user graph 122 and/or the tenancy graph 126. With more specificity, the graph application 108 may generate a vector representation of the user graph and/or the tenancy graph. The AI personalization application 110 generates a vector representation of the keyword and searches the vector representation of the user graph 122 and/or the tenancy graph 126 in order to obtain the identifiers for the invitees or the potential invitees to the meeting and/or identifiers for the content that is to be or that may be included in the electronic invitation. The AI personalization application 110 may identify the tasks that are to be completed subsequent to the meeting and the content that is relevant to completing the tasks using the vector representation of the user graph 122 and/or the tenancy graph 126 and the vector representation.

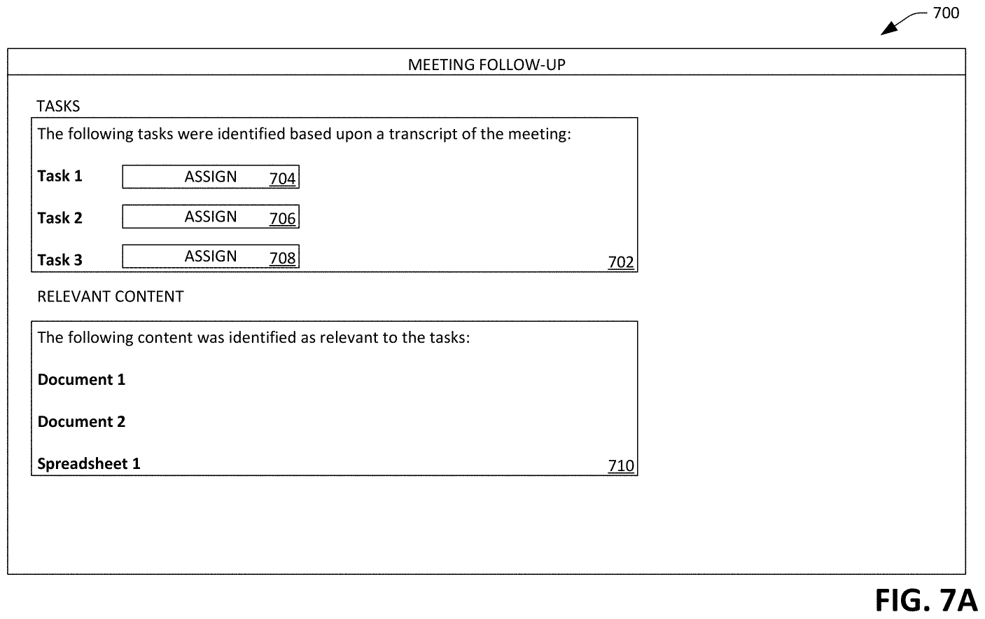

Turning now to FIG. 6, an example GUI 600 that facilitates AI driven personalization for electronic meeting creation is depicted. In an example, the GUI 600 is presented on the display 154 by the client meeting application 142 and/or the client meeting surface application 144 executing on the organizer computing device 132. With more specificity, the GUI 600 may be presented on the display 154 subsequent to the AI personalization application 110 obtaining identifiers for (potential) invitees to a meeting and/or obtaining identifiers for content that may be included in an electronic invitation for the meeting (via the user graph 122 and/or the tenancy graph 126, described above). The GUI 600 depicts a graphical representation of the electronic invitation to the meeting. As such, the GUI 600 includes a title field 602 that is configured to receive a title of the meeting. As shown in the GUI 600, the title field 602 has received a title of “Project XYZ.” Using the processes described above, the AI personalization application 110 may obtain the identifiers for the invitees and the identifiers for the content based upon the title of the meeting received in the title field 602 via the user graph 122 and/or the tenancy graph 126.

The GUI 600 further includes a location field 604 that is configured to receive a location of the meeting in the event that some or all of the attendees of the meeting will physically meet. It is to be understood that the meeting may take place entirely over a network, and hence there may be no physical location at which each attendee of the meeting will meet together. Thus, it is to be understood that the location field 604 is optional and that the location field 604 need not receive the location of the meeting.

The GUI 600 includes a start date field 606 that is configured to receive a start date of the meeting and a start time field 608 that is configured to receive a start time of the meeting (on the start date). The start date and the start time are collectively referred to herein as the “start datetime.” The GUI 600 also includes an end date field 610 that is configured to receive an end date of the meeting and an end time field 612 that is configured to receive an end time of the meeting (on the end date). The end date and the end time are collectively referred to herein as the “end datetime.”

The GUI 600 further includes a details field 614 that is configured to receive additional details about the meeting as set forth by the user 124. Additionally or alternatively, the AI personalization application 110 may automatically identify and/or derive contextual data (e.g., an agenda of the meeting) based upon the user graph 122 and/or the tenancy graph 126 and a keyword (e.g., the title of the meeting). According to some embodiments where the GUI 600 is provided by an email application and where the electronic invitation is an email, the details field 614 corresponds to a body of the email.

The GUI 600 additionally includes an invite individuals field 616 that is configured to receive identifiers for individuals that are to be invited to the meeting (i.e., invitees) as manual input from the user 124. The GUI 600 also includes an invitee field 618 that is configured to display identifiers for invitees of the meeting and/or identifiers for potential invitees of the meeting. The identifiers for the invitees and/or the identifiers for the potential invitees may be added to the invitee field 618 based solely upon being identified by the AI personalization application 110 via the user graph 122 and/or the tenancy graph 126 or the identifiers for the invitees and/or the identifiers for the potential invitees may be added to the invitees field 618 based upon a combination of manual input set forth by the user 124 and automatic identification by the AI personalization application 110. In the example depicted in the GUI 600, the invitee field 618 includes an identifier for a second user that has been suggested and added as an invitee to the meeting by the AI personalization application 110, an identifier for a third user that has been suggested as an invitee by the AI personalization application 110 (but not yet added as an invitee), an identifier for a fourth user that has been suggested and added as an invitee to the meeting by the AI personalization application 110, and an identifier for a fifth user that has been manually added as an invitee by the user 124 via the invite individuals field 616. Each identifier displayed in the invitee field 618 may include an indication of why the user corresponding to the identifier was added to the invitee field 618 (e.g., suggested by the AI personalization application 110 or manually added by the user 124).

Invitees may be added or removed from the electronic invitation via input received within the invitee field 618. The second user, who is currently an invitee to the meeting, may be removed as an invitee to the meeting when the invitee field 618 receives a selection of the “X” located proximate to the identifier for the second user, whereas the third user, who is currently only a potential invitee to the meeting, may be added as an invitee to the meeting when the invitee field 618 receives a selection of the “+” located proximate to the identifier for the third user. It is to be understood that the identifiers displayed within the invitee field 618 may change as individuals are added to and/or removed from the electronic invitation for the meeting. For instance, as described above, when a potential invitee is added as an invitee to the meeting, the AI personalization application 110 identifies different subgraphs within the user graph 122 and/or the tenancy graph 126, identify further potential invitees (or further potential content) based upon the different subgraphs, and cause identifiers for the further potential invitees (or the further potential content) to be displayed within the invitee field 618 (or elsewhere within the GUI 600).

The GUI 600 additionally includes an attach content field 620 that is configured to receive identifiers for content (e.g., documents, slideshow presentations, spreadsheets, emails, audio files, video files, etc.) that is to be included (e.g., attached to or linked to) in the electronic invitation for the meeting. Upon being selected, the attach content field 620 may display a pop-up window that enables the user 124 to navigate through a file system in order to locate the content. The GUI 600 also includes a suggested content field 622 that is configured to display identifiers for content that is to be included in the electronic invitation and/or identifiers for content that is suggested to be included in the electronic invitation. The identifiers for the content and/or the identifiers for the suggested content may be added to the suggested content field 622 based solely upon being identified by the AI personalization application 110 via the user graph 122 and/or the tenancy graph 126 or the identifiers for the content and/or the identifiers for the suggested content may be added to the suggested content field 622 based upon a combination of manual input set forth by the user 124 and automatic identification by the AI personalization application 110. Similar to the invitee field 620, content may be added and/or removed from the suggested content field 622 via selections of the identifiers for the content and/or the identifiers for the suggested content. It is to be understood that the identifiers displayed within the suggested content field 622 may change as content is added to and/or removed from the electronic invitation for the meeting. When content is included in the electronic invitation, the AI personalization application 110 may identify different subgraphs within the user graph 122 and/or the tenancy graph 126, identify further potential invitees (or further content) based upon the different subgraphs, and cause identifiers for the further potential invitees (or further content) to be displayed within the invitee field 618 (or the invitee field 618).

The GUI 600 further includes a send invite button 624. When the send invite button 624 is selected by the user 124, the client meeting surface application 144 and/or the server meeting surface application 118 (or the client meeting application 142 and/or the server meeting application 116) generate the electronic invitation for the meeting based upon information received in the fields 602-620 and cause the meeting invitation to be transmitted, over a network connection, to an electronic account of each invitee that has been identified as being included in the electronic invitation. The electronic invitation includes the content that has been identified as being included in the electronic invitation as set forth in the suggested content field 622.

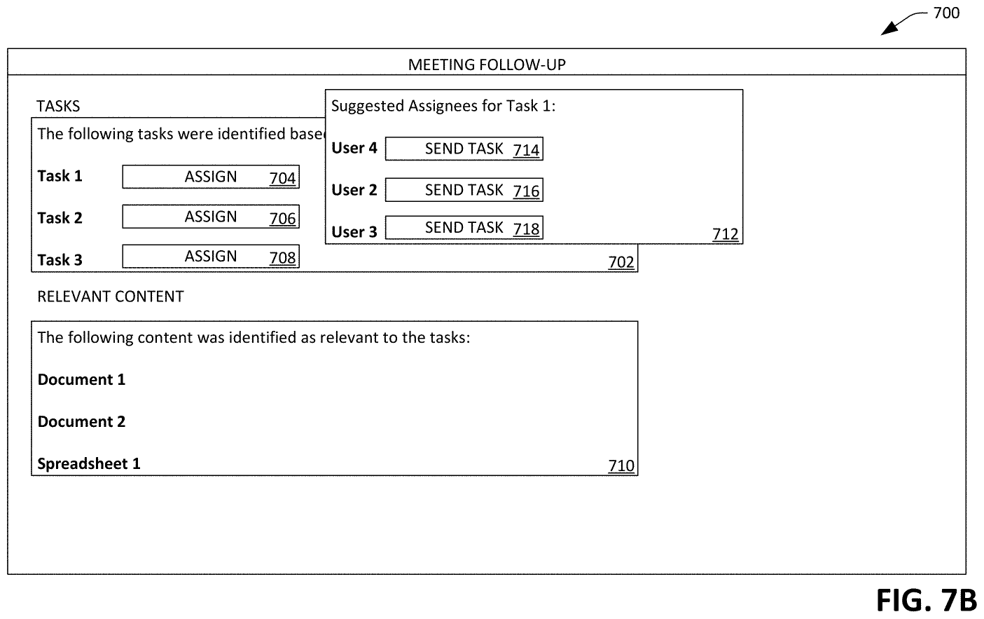

FIGS. 7A-B depict example GUIs that facilitate AI driven personalization for electronic meeting follow-up. Referring specifically now to FIG. 7A, a GUI 700 for electronic meeting follow-up is depicted. In an example, the GUI 700 is presented on the display 154 by the client meeting application 142 and/or the client meeting surface application 144 executing on the organizer computing device 132 after occurrence of a meeting. With more specificity, the GUI 700 may be presented on the display 154 after the AI personalization application 110 has obtained tasks that are to be completed via the user graph 122 and/or the tenancy graph 126 (described above).

The GUI 700 includes a task field 702 that is configured to display identifiers for tasks that are to be completed subsequent to occurrence of the meeting. The tasks have been obtained by the AI personalization application 110 via the user graph 122 and/or the tenancy graph 126 based upon one or more keywords and an identifier for the user 124. Each task has an assignment button assigned thereto (e.g., a first task may have a first assignment button 704, a second task may have a second assignment button 706, and a third task may have a third assignment button 708). When an assignment button is selected, a task corresponding to the assignment button may be assigned to one of the attendees of the meeting (or another individual who did not attend the meeting). The GUI 700 further includes a relevant content field 710. The relevant content field 710 is configured to display identifiers for content that has been identified as relevant to the tasks by the AI personalization application 110 via the user graph 122 and/or the tenancy graph 126 (described above). The AI personalization application 110 may rank the content such that an identifier for content that is most relevant to one or more of the tasks is presented at a top-most portion of the relevant content field 710. When an identifier for content is selected, client meeting application 142 and/or the client meeting surface application 144 may present the content to the user 124 such that the user 124 may inspect the content.

Turning now to FIG. 7B, the GUI 700 is depicted after receiving a selection of the first assignment button 704 by the user 124. Upon receiving the selection of the first assignment button 704, a suggested assignee field 712 is presented within the GUI 700. The suggested assignee field 712 is configured to display identifiers for suggested assignees for the first task and send task buttons 714-718 respectively assigned thereto. The AI personalization application 110 has obtained the identifiers for the suggested assignees via the user graph 122 and/or the tenancy graph 126 based upon one or more keywords and an identifier for the user 124. The AI personalization application 110 may rank the suggested assignees (via processing of the user graph 122 and/or the tenancy graph 126) such that an identifier for a suggested assignee that is most suited to complete the task is placed at the beginning of the identifiers for the suggested assignees. In an example, the GUI 700 receives a selection of the send task button 714, which causes the first task to be assigned to a fourth user (who may or may not have attended the meeting). Some or all of the content identified in the relevant content field 710 may be included in a notification sent to the fourth user informing the fourth user that the fourth user has been assigned the first task.

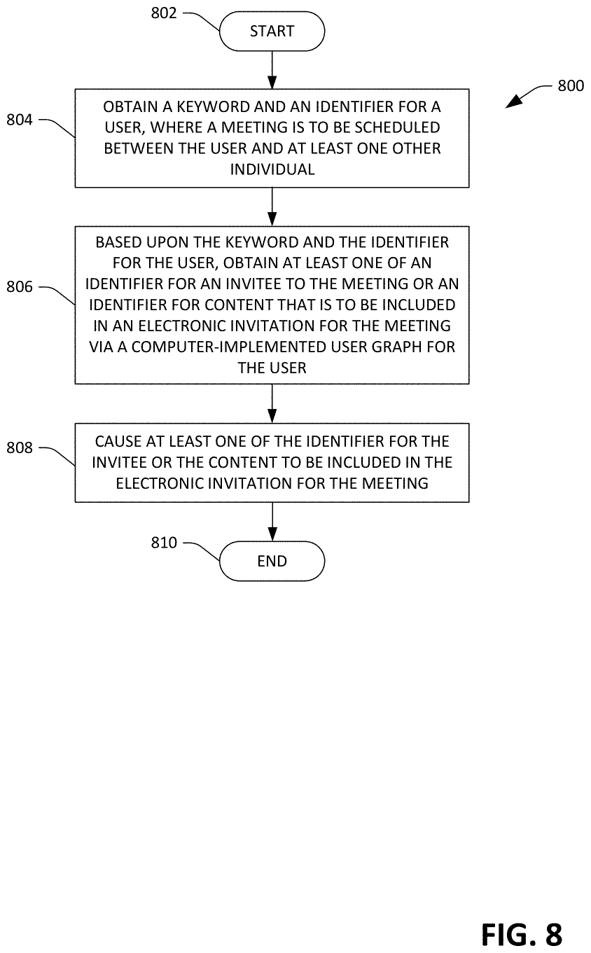

FIGS. 8-10 illustrate example methodologies relating to AI driven personalization for electronic meeting creation and follow-up. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring now to FIG. 8, an example methodology 800 executed by a computing system that facilitates AI driven personalization for electronic meeting creation is illustrated. The methodology 800 begins at 802, and at 804, the computing system obtains a keyword and an identifier for a user. A meeting is to be scheduled between the user and at least one other individual. At 806, based upon the keyword and the identifier for the user, the computing system obtains at least one of an identifier for an invitee to the meeting or an identifier for content that is to be included in an electronic invitation for the meeting via a computer-implemented user graph for the user. The user graph includes nodes that represent entities and edges connecting the nodes that represent relationships between the entities, where the user graph is identified from amongst several computer-implemented user graphs based upon the identifier for the user. At 808, the computing system causes at least one of the identifier for the invitee or the content to be included in the electronic invitation for the meeting. The electronic invitation for the meeting is transmitted, via a network, to invitees that are identified in the electronic invitation. The methodology 800 concludes at 810.

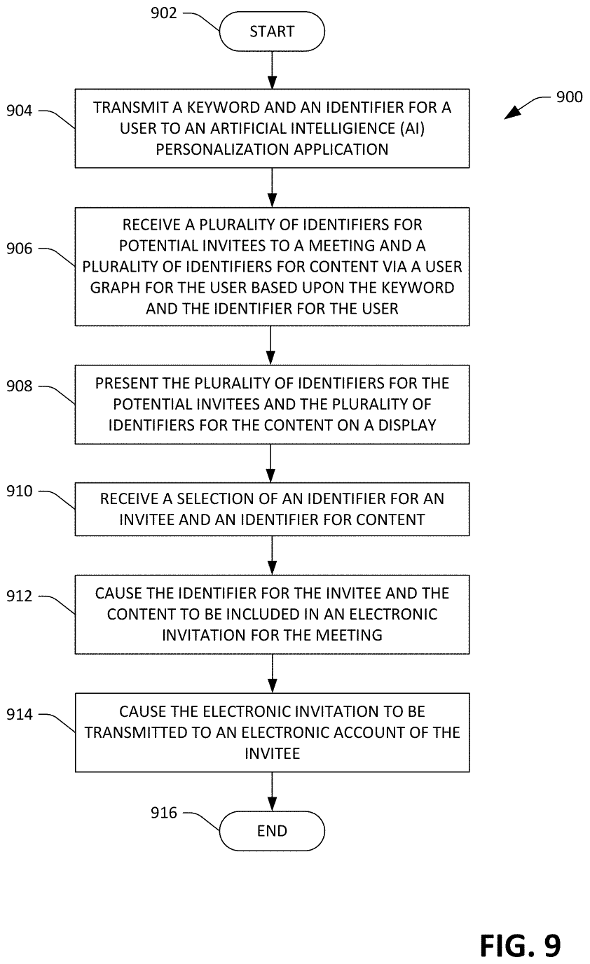

Turning now to FIG. 9, an example methodology 900 executed by a computing device operated by a user that facilitates AI driven personalization for electronic meeting creation and follow-up is illustrated. The methodology 900 begins at 902, and at 904, the computing device transmits a keyword and an identifier for the user to an AI personalization application. At 906, the computing device receives, from the AI personalization application and based upon the keyword and the identifier for the user, a plurality of identifiers for potential invitees to a meeting and a plurality of identifiers for content that may be included in an electronic invitation for the meeting. The AI personalization application obtains the plurality of identifiers for the potential invitees and the plurality of identifiers for the content via a computer-implemented user graph for the user. At 908, the computing device presents the plurality of identifiers for the potential invitees and the plurality of identifiers for the content on a display. At 910, the computing device receives a selection of an identifier of an invitee in the plurality of identifiers for the potential invitees and a selection of an identifier for content in the plurality of identifiers for the content that may be included in the electronic invitation. At 912, the computing device causes the identifier for the invitee and the (selected) content to be included in the electronic invitation for the meeting. At 914, the computing device causes the electronic invitation to be transmitted to an electronic account of the invitee, where the electronic invitation is transmitted to the invitee based upon the identifier for the invitee being included in the electronic invitation and where the content is included in the electronic invitation based upon the identifier for the content being selected by the user. The methodology 900 concludes at 916.

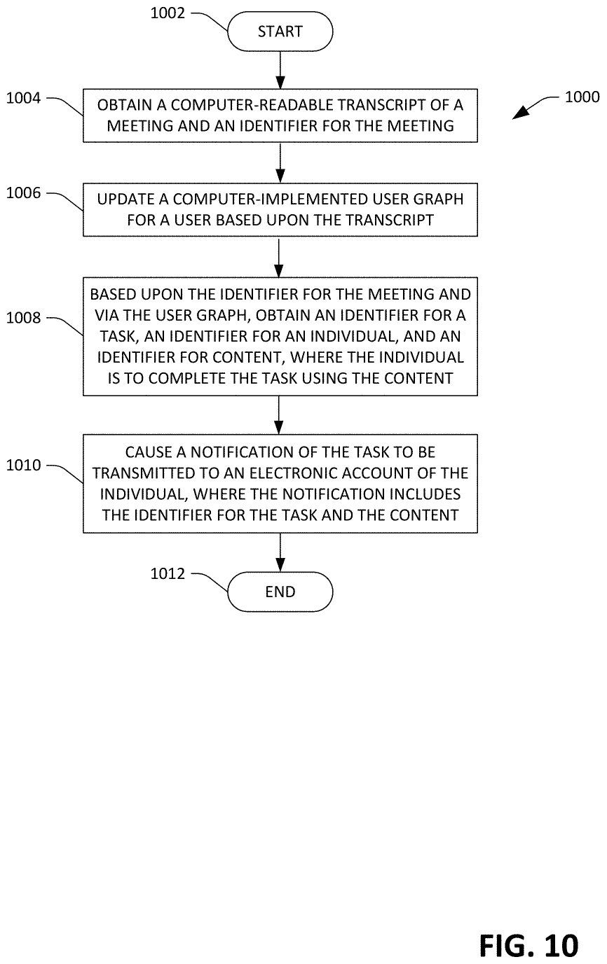

With reference now to FIG. 10, an example methodology 1000 executed by a computing system that facilitates AI driven personalization for electronic meeting follow-up is illustrated. The methodology 1000 begins at 1002, and at 1004, the computing system obtains a computer-readable transcript of a meeting and an identifier for the meeting. At 1006, the computing system updates a computer-implemented user graph for a user based upon the transcript. The user graph includes nodes that represent entities and edges connecting the nodes that represent relationships between the entities, and as such, the computing system modifies at least one node and/or edge of the user graph based upon the transcript. For instance, the computing system associates the transcript with a node representing the meeting in the user graph. At 1008, based upon the identifier for the meeting and via the updated user graph, the computing system obtains an identifier for a task, an identifier for an individual, and an identifier for content. The task is to be completed by the individual using the content. At 1010, the computing system causes a notification of the task to be transmitted to an electronic account of the individual. The notification includes the identifier for the task and the content. The methodology 1000 concludes at 1012.

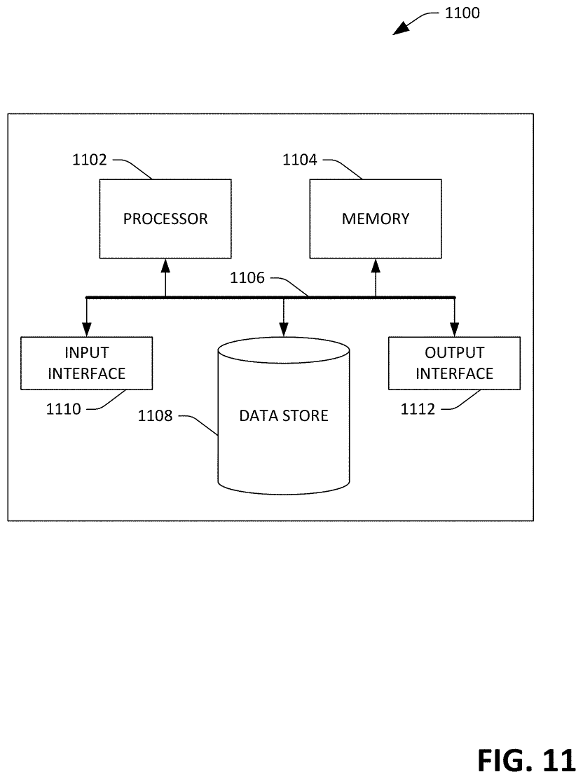

Referring now to FIG. 11, a high-level illustration of an example computing device 1100 that can be used in accordance with the systems and methodologies disclosed herein is illustrated. The computing device 1100 may be used in a system that identifies invitees for a meeting and/or identifies computer-readable content that is to be included in an electronic invitation for the meeting. The computing device 1100 can also be used in a system that hosts an electronic meeting over a network connection between at least two individuals. The computing device 1100 includes at least one processor 1102 that executes instructions that are stored in a memory 1104. The instructions may be instructions for implementing functionality described as being carried out by one or more components discussed above or instructions for implementing one or more of the methods described above. The processor 1102 may access the memory 1104 by way of a system bus 1106. In addition to storing executable instructions, the memory 1104 may also store user graphs, tenancy graphs, vector representations of graphs, contextual data, audio-visual recordings of electronic meetings, transcripts of electronic meetings, computer-readable content (e.g., documents, emails, and so forth), etc.

The computing device 1100 additionally includes a data store 1108 that is accessible by the processor 1102 by way of the system bus 1106. The data store 1108 may include executable instructions, user graphs, tenancy graphs, vector representations of graphs, contextual data, audio-visual recordings of electronic meetings, transcripts of electronic meetings, computer-readable content (e.g., documents, emails, and so forth), etc. The computing device 1100 also includes an input interface 1110 that allows external devices to communicate with the computing device 1100. The input interface 1110 may be used to receive instructions from an external computer device, from a user, etc. The computing device 1100 also includes an output interface 1112 that interfaces the computing device 1100 with one or more external devices. The computing device 1100 may display text, images, etc. by way of the output interface 1112.

It is contemplated that the external devices that communicate with the computing device 1100 via the input interface 1110 and the output interface 1112 can be included in an environment that provides substantially any type of user interface with which a user can interact. Examples of user interface types include graphical user interfaces, natural user interfaces, and so forth. A graphical user interface may accept input from a user employing input device(s) such as a keyboard, mouse, remote control, or the like and provide output on an output device such as a display. Further, a natural user interface may enable a user to interact with the computing device 1100 in a manner free from constraints imposed by input devices such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1100 may be a distributed system. Thus, several devices may be in communication by way of a network connection and may collectively perform tasks described as being performed by the computing device 1100.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. Such computer-readable storage media can comprise random-access memory (RAM), read-only memory (ROM), electrically erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. Illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The present disclosure relates to systems and methods for AI driven personalization for electronic meeting creation and follow-up according to at least the examples provided in the sections below:

(A1) In one aspect, some embodiments include a method that facilitates AI driven personalization for electronic meeting creation and follow-up. The method is executed by a processor (e.g., 104) of a computing system (e.g., 102). The method includes (a) obtaining (e.g., 804) a keyword and an identifier for a user (e.g., 124) A meeting is to be scheduled between the user and at least one other individual. The method further includes (b) based upon the keyword and the identifier for the user, obtaining (e.g., 806) at least one of an identifier for an invitee to the meeting or an identifier for content that is to be included in an electronic invitation for the meeting via a computer-implemented user graph (e.g., 122) for the user. The user graph includes nodes that represent entities and edges connecting the nodes that represent relationships between the entities. The user graph is identified from amongst several computer-implemented user graphs based upon the identifier for the user. The method additionally (c) includes causing (e.g., 808) at least one of the identifier for the invitee or the content to be included in the electronic invitation for the meeting. The electronic invitation for the meeting is transmitted, via a network (e.g., 134), to electronic accounts of invitees that are identified in the electronic invitation.

(A2) In some of the embodiments of the method of A1, the method further includes based upon the keyword and the identifier for the user, identifying at least one tenancy of the user; for each identified tenancy and based upon the keyword and the identifier for the user, obtaining at least one of an identifier for a second invitee to the meeting or an identifier for second content that is to be included in the electronic invitation for the meeting via a computer-implemented tenancy graph (e.g., 126) for a tenancy of the user, the tenancy graph including second nodes that represent second entities and second edges connecting the second nodes that represent second relationships between the second entities; and prior to the electronic invitation being transmitted to the electronic accounts of the invitees, causing at least one of the identifier for the second invitee or the second content to be included in the electronic invitation for the meeting.

(A3) In some of the embodiments of any of the methods of A1-A2, the at least one tenancy of the user is further identified based upon access control information for the user.

(A4) In some of the embodiments of any of the methods of A1-A3, the identifier for the invitee to the meeting is obtained via the user graph. The method further includes subsequent to obtaining the identifier for the user and prior to the electronic invitation for the meeting being transmitted to the electronic accounts of the invitees, causing the identifier for the invitee to be presented on a display (e.g., 154) to the user, where the identifier for the invitee is selected by the user, thereby causing the identifier for the invitee to be included in the electronic invitation.

(A5) In some of the embodiments of any of the methods of A1-A4, the method further includes upon receiving an indication that the identifier for the invitee has been selected by the user, identifying a tenancy of the user based upon the identifier for the user; based upon the identifier for the invitee, the keyword, and the identifier for the user, obtaining at least one of an identifier for a second invitee to the meeting or an identifier for second content that is to be included in the electronic invitation for the meeting via a tenancy graph for the tenancy, the tenancy graph including second nodes that represent second entities and second edges connecting the second nodes that represent second relationships between the second entities; and prior to the electronic invitation for the meeting being transmitted to the electronic accounts of the invitees, causing the at least one of the identifier for the second invitee to the meeting or the identifier for the second content to be included in the electronic invitation for the meeting.

(A6) In some of the embodiments of any of the methods of A1-A5, the electronic account is an email account of the attendee, where the notification is an email.

(A7) In some of the embodiments of any of the methods of A1-A6, the method further includes receiving an indication of a preferred skill set, where the identifier for the invitee is obtained via the user graph for the user additionally based upon the indication of the preferred skill set.

(B1) In another aspect, some embodiments include a computing system (e.g., 102) that includes a processor (e.g., 104) and memory (e.g., 106). The memory stores instructions that, when executed by the processor, cause the processor to perform any of the methods described herein (e.g., any of A1-A7).

(C1) In yet another aspect, a non-transitory computer-readable storage medium includes instructions that, when executed by a processor (e.g., 104) of a computing system (e.g., 102), cause the processor to perform any of the methods described herein (e.g., any of A1-A7).

(D1) In another aspect, some embodiments include a method executed by a computing system that includes a processor (e.g., 104) and memory (e.g., 106). The method includes obtaining a keyword and an identifier for a user (e.g., 124), where a meeting is to be scheduled between the user and at least one other individual. The method further includes based upon the keyword and the identifier for the user, obtaining at least one of an identifier for an invitee to the meeting or an identifier for content that is to be included in an electronic invitation for the meeting via a computer-implemented user graph (e.g., 122) for the user. The user graph includes nodes that represent entities and edges connecting the nodes that represent relationships between the entities. The user graph is identified from amongst several computer-implemented user graphs based upon the identifier for the user. The method additionally includes causing at least one of the identifier for the invitee or the content to be included in the electronic invitation for the meeting, where the electronic invitation for the meeting is transmitted, via a network (e.g., 134), to electronic accounts of invitees that are identified in the electronic invitation.

(D2) In some of the embodiments of the method of D1, obtaining the at least one of the identifier for the invitee or the identifier for the content includes identifying at least one seed node in the user graph, the at least one seed node representing at least one topic that corresponds to the keyword; and identifying at least one second level node in the user graph connected to the at least one seed node via at least one edge, where the at least one second level node represents the invitee or the content.

(D3) In some of the embodiments of any of the methods of D1-D2, obtaining the at least one of the identifier for the invitee or the identifier for the content includes generating a vector representation of at least a portion of the user graph; generating a vector representation of the keyword; and identifying the at least one of the identifier for the invitee or the identifier for the content based upon the vector representation of the at least the portion of the user graph and the vector representation of the keyword.

(D4) In some of the embodiments of any of the methods of D1-D3, the keyword is a title of the meeting.

(D5) In some of the embodiments of any of the methods of D1-D4, the identifier for the content is presented on a display (e.g., 154) of a computing device (e.g., 132) operated by the user, where the keyword is obtained based upon a selection of the identifier for the content by the user.

(D6) In some of the embodiments of any of the methods of D1-D5, the electronic invitation is transmitted to an electronic account of the invitee when the identifier for the invitee is included in the electronic invitation.

(D7) In some of the embodiments of any of the methods of D1-D6, the method further includes prior to obtaining the keyword and the identifier for the user, obtaining user activity data for the user from a plurality of applications; and generating the user graph based upon the user activity data.

(D8) In some of the embodiments of any of the methods of D1-D7, the content is attached to the electronic invitation or linked to within the electronic invitation when the identifier for the content is included in the electronic invitation.

(D9) In some of the embodiments of any of the methods of D1-D8, the content includes a document; a spreadsheet; a slideshow presentation; an email; a video recording; or an audio recording.

(D10) In some of the embodiments of any of the methods of D1-D9, a meeting surface application (e.g., 118, 144) generates the electronic invitation for the meeting and causes the electronic invitation to be transmitted to the electronic accounts of the invitees, wherein the meeting occurs over the network via respective instances of a meeting application (e.g., 116, 142) executing on respective computing devices of attendees of the meeting.

(E1) In another aspect, a computing system (e.g., 102) includes a processor (e.g., 104) and memory (e.g., 106). The memory stores instructions that, when executed by the processor, cause the processor to perform any of the methods described herein (e.g., any of D1-D10).

(F1) In yet another aspect, a non-transitory computer-readable storage medium includes instructions that, when executed by a processor (e.g., 104) of a computing system (e.g., 102), cause the processor to perform any of the methods described herein (e.g., any of D1-D10).

(G1) In another aspect, some embodiments include a method executed by a computing system (e.g., 102) that includes a processor (e.g., 104) and memory (e.g., 106). The method includes obtaining a keyword and an identifier for a user, where a meeting is to be scheduled between the user (e.g., 124) and at least one other individual. The method further includes based upon the keyword and the identifier for the user, obtaining an identifier for an invitee to the meeting via a computer-implemented user graph (e.g., 122) for the user. The user graph includes nodes that represent entities and edges connecting the nodes that represent relationships between the entities. The user graph is identified from amongst several computer-implemented user graphs based upon the identifier for the user. The method additionally includes based upon the keyword, the identifier for the user, and the identifier for the invitee, obtaining an identifier for content that is to be included in an electronic invitation for the meeting via the user graph. The method also includes causing the identifier for the invitee and the content to be included in the electronic invitation for the meeting, where the electronic invitation for the meeting is transmitted, via a network (e.g., 134), to an electronic account of the invitee based upon the identifier for the invitee being included in the electronic invitation, where the content is included in the electronic invitation based upon the identifier for the content being included in the electronic invitation.

(G2) In some of the embodiments of the method of G1, the user graph includes a topic node that represents a topic corresponding to the keyword, a first node that represents the invitee, and a second node that represents the content, where a first edge connects the topic node to the first node within the user graph, where a second edge connects the first node to the second node within the user graph, where the identifier for the invitee is obtained based upon a first walk of the user graph from the topic node to the first node via the first edge, where the identifier for the content is obtained based upon a second walk of the user graph from the first node to the second node via the second edge.

(G3) In some of the embodiments of any of the methods of G1-G2, the computing system is a server computing device, where the keyword and the identifier for the user are received by the server computing device from a client computing device (e.g., 132) operated by the user.

(H1) In another aspect, a computing system (e.g., 102) includes a processor (e.g., 104) and memory (e.g., 106). The memory stores instructions that, when executed by the processor, causes the processor to perform any of the methods described herein (e.g., any of G1-G3).

(I1) In yet another aspect, a non-transitory computer-readable storage medium includes instructions that, when executed by a processor (e.g., 104) of a computing system (e.g., 102), cause the processor to perform any of the methods described herein (e.g., any of G1-G3).

As used herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system, comprising:
a processor; and
memory storing instructions that, when executed by the processor, cause the processor to perform acts comprising:
obtaining a keyword and an identifier for a user, wherein a meeting is to be scheduled between the user and at least one other individual;
based upon the keyword and the identifier for the user, obtaining at least one of an identifier for an invitee to the meeting or an identifier for content that is to be included in an electronic invitation for the meeting via a computer-implemented user graph for the user, the user graph comprising nodes that represent entities and edges connecting the nodes that represent relationships between the entities, wherein the user graph is identified from amongst several computer-implemented user graphs based upon the identifier for the user; and
causing at least one of the identifier for the invitee or the content to be included in the electronic invitation for the meeting, wherein the electronic invitation for the meeting is transmitted, via a network, to electronic accounts of invitees that are identified in the electronic invitation.

2. The computing system of claim 1, wherein obtaining the at least one of the identifier for the invitee or the identifier for the content comprises:
identifying at least one seed node in the user graph, the at least one seed node representing at least one topic that corresponds to the keyword; and
identifying at least one second level node in the user graph connected to the at least one seed node via at least one edge, wherein the at least one second level node represents the invitee or the content.

3. The computing system of claim 1, wherein obtaining the at least one of the identifier for the invitee or the identifier for the content comprises:
generating a vector representation of at least a portion of the user graph;
generating a vector representation of the keyword; and
identifying the at least one of the identifier for the invitee or the identifier for the content based upon the vector representation of the at least the portion of the user graph and the vector representation of the keyword.

4. The computing system of claim 1, wherein the keyword is a title of the meeting.

5. The computing system of claim 1, wherein the identifier for the content is presented on a display of a computing device operated by the user, wherein the keyword is obtained based upon a selection of the identifier for the content by the user.

6. The computing system of claim 1, wherein the electronic invitation is transmitted to an electronic account of the invitee when the identifier for the invitee is included in the electronic invitation.

7. The computing system of claim 1, the acts further comprising:
prior to obtaining the keyword and the identifier for the user, obtaining user activity data for the user from a plurality of applications; and
generating the user graph based upon the user activity data.

8. The computing system of claim 1, wherein the content is attached to the electronic invitation or linked to within the electronic invitation when the identifier for the content is included in the electronic invitation.

9. The computing system of claim 8, wherein the content comprises:
a document;
a spreadsheet;
a slideshow presentation;
an email;
a video recording; or
an audio recording.

10. The computing system of claim 1, wherein a meeting surface application generates the electronic invitation for the meeting and causes the electronic invitation to be transmitted to the electronic accounts of the invitees, wherein the meeting occurs over the network via respective instances of a meeting application executing on respective computing devices of attendees of the meeting.

11. A method executed by a processor of a computing system, the method comprising:
obtaining a keyword and an identifier for a user, wherein a meeting is to be scheduled between the user and at least one other individual;
based upon the keyword and the identifier for the user, obtaining at least one of an identifier for an invitee to the meeting or an identifier for content that is to be included in an electronic invitation for the meeting via a computer-implemented user graph for the user, the user graph comprising nodes that represent entities and edges connecting the nodes that represent relationships between the entities, wherein the user graph is identified from amongst several computer-implemented user graphs based upon the identifier for the user; and
causing at least one of the identifier for the invitee or the content to be included in the electronic invitation for the meeting, wherein the electronic invitation for the meeting is transmitted, via a network, to electronic accounts of invitees that are identified in the electronic invitation.

12. The method of claim 11, further comprising:
based upon the keyword and the identifier for the user, identifying at least one tenancy of the user;
for each identified tenancy and based upon the keyword and the identifier for the user, obtaining at least one of an identifier for a second invitee to the meeting or an identifier for second content that is to be included in the electronic invitation for the meeting via a computer-implemented tenancy graph for a tenancy of the user, the tenancy graph comprising second nodes that represent second entities and second edges connecting the second nodes that represent second relationships between the second entities; and
prior to the electronic invitation being transmitted to the electronic accounts of the invitees, causing at least one of the identifier for the second invitee or the second content to be included in the electronic invitation for the meeting.

13. The method of claim 12, wherein the at least one tenancy of the user is further identified based upon access control information for the user.

14. The method of claim 11, wherein the identifier for the invitee to the meeting is obtained via the user graph, the method further comprising:
subsequent to obtaining the identifier for the user and prior to the electronic invitation for the meeting being transmitted to the electronic accounts of the invitees, causing the identifier for the invitee to be presented on a display to the user, wherein the identifier for the invitee is selected by the user, thereby causing the identifier for the invitee to be included in the electronic invitation.

15. The method of claim 14, further comprising:
upon receiving an indication that the identifier for the invitee has been selected by the user, identifying a tenancy of the user based upon the identifier for the user;
based upon the identifier for the invitee, the keyword, and the identifier for the user, obtaining at least one of an identifier for a second invitee to the meeting or an identifier for second content that is to be included in the electronic invitation for the meeting via a tenancy graph for the tenancy, the tenancy graph comprising second nodes that represent second entities and second edges connecting the second nodes that represent second relationships between the second entities; and
prior to the electronic invitation for the meeting being transmitted to the electronic accounts of the invitees, causing the at least one of the identifier for the second invitee to the meeting or the identifier for the second content to be included in the electronic invitation for the meeting.

16. The method of claim 11, wherein the electronic account is an email account of the attendee, wherein the notification is an email.

17. The method of claim 16, further comprising:
receiving an indication of a preferred skill set, wherein the identifier for the invitee is obtained via the user graph for the user additionally based upon the indication of the preferred skill set.

18. A non-transitory computer-readable storage medium comprising instructions that, when executed by a processor of a computing system, cause the processor to perform acts comprising:
obtaining a keyword and an identifier for a user, wherein a meeting is to be scheduled between the user and at least one other individual;
based upon the keyword and the identifier for the user, obtaining an identifier for an invitee to the meeting via a computer-implemented user graph for the user, the user graph comprising nodes that represent entities and edges connecting the nodes that represent relationships between the entities, wherein the user graph is identified from amongst several computer-implemented user graphs based upon the identifier for the user;
based upon the keyword, the identifier for the user, and the identifier for the invitee, obtaining an identifier for content that is to be included in an electronic invitation for the meeting via the user graph; and
causing the identifier for the invitee and the content to be included in the electronic invitation for the meeting, wherein the electronic invitation for the meeting is transmitted, via a network, to an electronic account of the invitee based upon the identifier for the invitee being included in the electronic invitation, wherein the content is included in the electronic invitation based upon the identifier for the content being included in the electronic invitation.

19. The non-transitory computer-readable storage medium of claim 18, wherein the user graph comprises a topic node that represents a topic corresponding to the keyword, a first node that represents the invitee, and a second node that represents the content, wherein a first edge connects the topic node to the first node within the user graph, wherein a second edge connects the first node to the second node within the user graph, wherein the identifier for the invitee is obtained based upon a first walk of the user graph from the topic node to the first node via the first edge, wherein the identifier for the content is obtained based upon a second walk of the user graph from the first node to the second node via the second edge.

20. The non-transitory computer-readable storage medium of claim 18, wherein the computing system is a server computing device, wherein the keyword and the identifier for the user are received by the server computing device from a client computing device operated by the user.
